(19) United States
(12) Patent Application Publication
(10) Pub. No.: US 2002/0188488 A1
(43) Pub. Date: Dec. 12, 2002

(54) Methods and systems for simulating business operations

(76) Inventor: Burl Shannon Hinkle, High Point, NC (US)

Correspondence Address: John S. Beulick, Armstrong Teasdale LLP, One Metropolitan Sq., Suite 2600, St. Louis, MO, 63102, US

(21) Appl. No.: 09/845,397

(22) Filed: Apr. 30, 2001

(51) Int. Cl. G06F 17/60

(52) U.S. Cl. 705/8; 705/7

(57) ABSTRACT

A method for modeling the operations of a business includes prompting a user to input data relating to at least one of volume, assignments, cash application, adjustments, collections, client services, tolerance, labor, file/mail/imaging, and capacity, determining from the data whether the staff of the business has capacity to carry out tasks of the business, and displaying at least one scenario generated from the input data and capacity determination.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to business operations, and more specifically to systems and methods used for operations simulation within a business.

Operations simulation, as used herein, refers to processes and systems for simulating the dynamics of a business over a period of time to determine resource needs within specific areas of the business. Accurate determination of such resource needs allows a company to staff up/down or shift employee resources in response to changing business needs. Operations simulation is important as businesses strive to achieve efficient allocation of resources, and in particular of personnel. Having too many personnel raises business overhead and typically erodes profit margin, while having too few personnel leads to delay in processing and other transactions that can adversely affect the competitiveness of the business.

The importance of operations simulation is magnified when the business operations are largely or exclusively labor intensive. For example, in a financial services business, employees within a collections department account for a large portion of the cost for running the collections department. Having prior knowledge of the number of employees needed to properly staff a collections department is invaluable for keeping the costs for such a department under control. Other departments within a financial services business, for example, cash applications, adjustments and client services also have fluctuating staffing needs which if known in advance will allow for further staffing planning on the company's part. Fluctuating staffing needs within a financial services company are caused by many reasons, one example is, seasonal financing trends of the business' customers.

### BRIEF SUMMARY OF THE INVENTION

In one aspect, there is provided a method for operating a computer to model operations of a business. The method comprising prompting a user to input data relating to at least one of volume, assignments, cash application, adjustments, collections, client services, tolerance, labor, file/mail/imaging, and capacity, determining from the data whether the staff of the business has capacity to carry out tasks of the business, and displaying at least one scenario generated based on the input data and capacity determination.

In another aspect a computer is provided which is programmed to prompt a user to input data relating to at least one of volume, assignments, cash application, adjustments, collections, client services, tolerance, labor, file/mail/imaging, and capacity, determine from the data whether the staff of the business has capacity to carry out tasks of the business, and display a computer generated screen which comprises at least one scenario generated from the input data and capacity determination.

In still another aspect, a database is provided which comprises data corresponding to at least one of a business' volume, assignments, cash applications, adjustments, collections, client services, tolerance, labor, and file/mail/imaging, and data corresponding to a determination of a number of employees needed to carry out tasks of the business.

In yet another aspect, a system for use in a financial services business is provided, where the system comprises a server configured to determine an operations capacity for the business based upon data relating to at least one of volume, assignments, cash application, adjustments, collections, client services, tolerance, labor, and file/mail/imaging, and a database comprising data corresponding to at least one of a business' volume, assignments, cash applications, adjustments, collections, client services, tolerance, labor, and file/mail/imaging and data corresponding to a determination of a number of employees needed to carry out tasks of the business.

In another aspect, a computer program embodied on a computer-readable medium for managing business operations is provided which comprises a code segment to process data relating to at least one of a business' volume, assignments, cash application, adjustments, collections, client services, tolerance, labor, and file/mail/imaging and a code segment to analyze based on a plurality of rules for calculating a number of employees needed to carry out tasks of the business.

### BRIEF DESCRIPTION OF THE DRAWINGS

FIG. 1 is a block diagram of a system in accordance with one embodiment of the present invention.

FIG. 2 is an expanded version block diagram of an exemplary embodiment of a server architecture of an alternative system.

FIG. 3 is a flow diagram of a network-based method for simulating the operations of a business.

FIG. 4 is a spreadsheet indicating independent variables to be input into a base model.

FIG. 5 is a continuation of the spreadsheet of FIG. 4.

FIG. 6 is a report which includes dependent variable outputs resulting from independent variable inputs into the base model.

FIGS. 7 through 11 are continuations of the report of FIG. 6.

FIG. 12 is matrix which shows a number of independent variables and scenarios which implement sequential changes to the independent variables within the base model.

FIGS. 13 and 14 are a spreadsheet showing independent variables to be inputted for a first scenario, which is run and compared to a base model.

FIGS. 15 through 42 are a scenario summary report including a baseline scenario and six other scenarios.

### DETAILED DESCRIPTION OF THE INVENTION

Exemplary embodiments of systems and methods for modeling the operations of a financial services business are described below in detail. The systems and processes are not limited to the specific embodiments described herein. In addition, components of each system and each process can be practiced independently and separately from other components and processes described herein. Further, each component and process can be used in combination with other components and processes.

The operations modeling system for forecasting business headcount requirements, cost, pricing, and capacity described herein is configured with a plurality of spreadsheets and reports to integrate a forecast of invoice processing, funding, cash application, cash adjustments, and collections involving the financial services business, a calculation of how many full-time employees (FTEs) are required to discharge the tasks relating to the forecast, and a comparison of the forecasted number of FTEs with the number of FTEs presently available. Based on process metrics and data including multiple independent variables, the system provides a forecast for multiple dependent variables including daily, monthly and yearly headcount requirements, process capacities, aspects critical to quality, and costs for multiple, separate process scenarios. The forecasting enables a detailed analysis of the impact of business decisions and allows lead-time to correct process inadequacies before customers are affected.

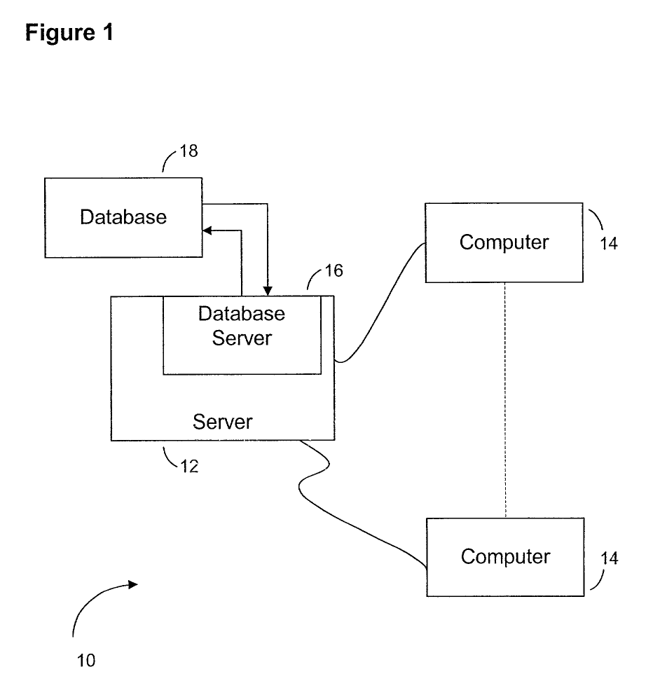

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

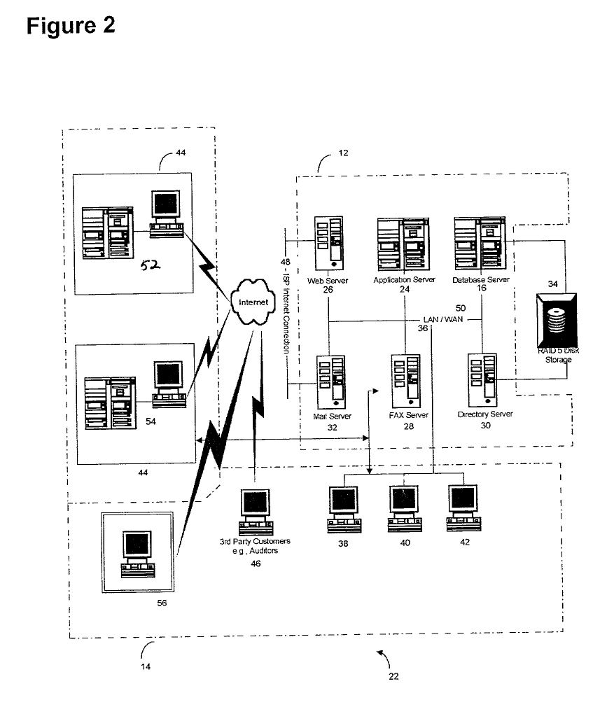

FIG. 2 is an expanded version block diagram of an exemplary embodiment of a server architecture of a system 22. Components in system 22 identical to components in system 10 (shown in FIG. 1), are identified in FIG. 2 using the same reference numerals as used in FIG. 1. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 52 can access server sub-system 12. One of user devices 14 includes a workstation 54 located at a remote location. Workstations 54 are personal computers having a web browser. Also, workstations 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

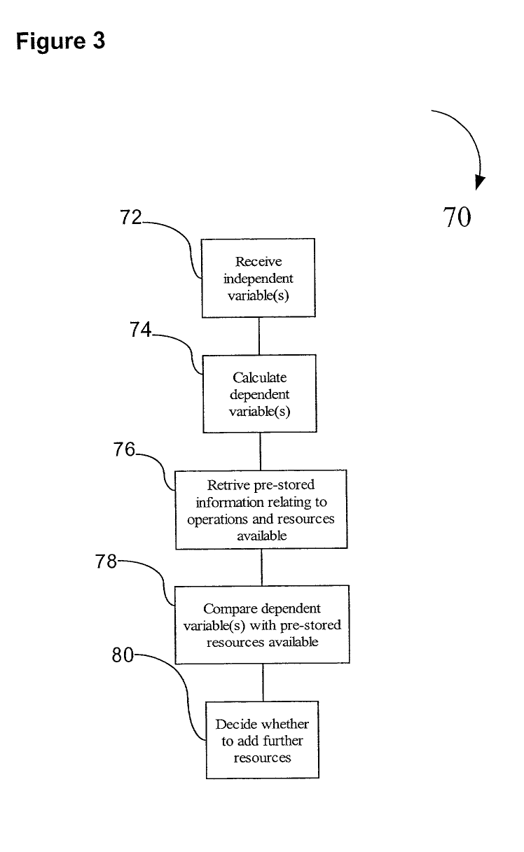

FIG. 3 is a flow diagram 70 for a network-based method for simulating the operations of a financial services business. System 10 (shown in FIG. 1) receives 72 information from a user comprising independent variables describing the business. In one embodiment, the user inputs the information into a device (such as device 14 shown in FIG. 1) that transmits the information to a server (such as server 12 shown in FIG. 1). The information is received from the user via a graphical user interface as will be described in greater detail below.

Example independent variables include, but are not limited to, net time worked, productive hours per day, percent of time not spent on primary task, time required per task, average tasks per dollar-based monthly volume (such as $1 million(1 MM)), daily volume, tolerance or critical-to-quality, work days allowable missed tolerance, ratio of assistants to primary task “doers”, and task input related to other part of process (percent errors).

From the independent variables input into the system, server 12 calculates 74 dependent variables relating to the operations of the financial services business. Examples of such dependent variables include daily capacity, number of full time employees (FTEs) (including employees in assignments, cash applications, adjustments, collections, client services and file/mail/imaging), number of new task items, and daily capacity. System 10 then retrieves 76 pre-stored information relating to operations of the financial services business, and in particular to the resources available to carry out the operations. System 10 compares 78 the dependent variables calculated with pre-stored information concerning the resources available to carry out the operations of the financial services business. System 10 decides 80 whether further resources, for example, more client services FTEs, are required to carry out the operations of the financial services business

In one exemplary embodiment, the application as described in flow diagram 70 is developed as an application under Microsoft Excel™. Microsoft Excel is a trademark of Microsoft Corporation, Redmond, Wash. In addition, the application incorporates a revision log for incorporating a listing of all changes and revisions to the spreadsheets by date. In the exemplary embodiment, the application is divided into integrated spreadsheets and reports including, but not limited to, a Base Summary, a Base Model, a Current Capacity, a Capacity Summary, and a Capacity Model. In an alternative embodiment, various customizable charts are provided for graphical analysis.

The embodiments described herein are in relationship with the financial services industry. The system and methods described, however, are adaptable to business environments in which specified work tasks recur and the time necessary to perform them can be determined. The system and methods indicate whether changing workload or staffing levels will create backlogs, the cost of those backlogs, and provides a hiring trigger to avoid creating a backlog. Exceeding the hiring trigger is an indicator that it is desirable to hire additional personnel.

One embodiment of the operations modeling program determines the capacity to carry out the tasks at hand and compares such capacity with the resources available to carry out the tasks. If the calculated capacity substantially exceeds the resources available, the program indicates that additional FTEs need to be hired. The operations modeling program includes capacity calculations to determine a number of employees needed to adequately staff invoice processing, cash applications, collections, cash adjustments, including credit memos and other, client services. Further, the modeling program is configured to determine costs per FTE.

Capacities are calculated from the equation

$$\frac{A \times B \times C \times 60 sec \text{/} min \times 60 min \text{/} hr \times ( 1 + D )}{E} = \text{capacity/day}$$

where, A=a number of FTEs, B=net time worked (hours), C=a productive number of hours per day, D=a percentage of possible overtime, and E=average time to complete tasks (seconds).

If the percent of possible overtime required is zero, then the FTE hiring trigger is not exceeded (i.e., is less than unity). A non-zero percent of possible overtime value indicates that the hiring trigger has been exceeded (i.e., is greater than unity) and additional personnel should be hired.

### Invoice Processing Capacity (assignments)

For calculation of invoice processing capacity A=number of assignments FTEs, and E=average invoice assignment time in seconds. The assignments FTE hiring trigger is assumed to be less than a number of work days that are allowable with a missed tolerance, and it is further assumed that

(a number of backlogged invoices is greater than allowable assignments backlog invoices per day) OR (a number of backlogged invoices is less than (0.8×allowable assignments backlog invoices day)).

The number of backlogged invoices is defined as

a number of new manual invoices+a number of backlogged invoices−a number of invoices processed,

where the number of new manual invoices is defined as

(daily volume×average manual invoices per 1 MM monthly volume)+(E-commerce business daily volume×E-commerce average manual invoices per 1 MM monthly volume).

In one exemplary embodiment, for invoice processing capacity, a percent net time worked is 90 percent, productive work hours/day is seven, average invoice assignment time is eight seconds, work days allowable missed tolerance is 5, an average number of manual invoices per 1 MM monthly volume is 368 and E-commerce average manual invoices per 1 MM monthly volume is zero.

### Cash Applications Capacity

For calculation of cash application capacity A=number of cash applications FTEs, and E=average record application time in seconds. The cash application FTE hiring trigger is assumed to be less than work days allowable missed tolerance, and it is further assumed that

(a number of backlogged records is greater than the allowable cash applications backlog records day) OR (a number of backlogged records is less than (0.8×allowable cash applications backlog records day)).

The number of backlogged records is defined as

a number of new manual records+a number of backlogged payments−a number of records applied,

where the number of new manual records is defined as

core daily net volume×core average payments per 1 MM monthly volume+E-business daily net volume×E-business average manual payment per 1 MM monthly volume.

In one exemplary embodiment, for cash application capacity, a percent net time worked is 90 percent, productive work hours/day is seven, average record application time is 100 seconds, work days allowable missed tolerance is 100, core average payments per 1 MM monthly volume is 133 and E-business average manual payment per 1 MM monthly volume is 75.

### Collections Capacity

Collection capacity is defined as a total number of customers cleared today and is calculated from

a number of customers cleared today by calling+a number of customers cleared by write-off+a number of customers cleared without collections,

where the number of customers cleared today by calling is defined as

outbound calling effectiveness×a number of calls made today,

and outbound calling effectiveness is defined as

a number of calls made per day÷a number of calls required to clear all customers.

A number of calls required to clear all customers is defined as

a number of calls per customer per month to clear customer×total number of past due customers÷a number of dates of the month.

A number of customers cleared by write-off is defined as

a percentage of daily volume as bad debt×daily volume amount÷average customer past due amount.

A number of calls made per day is defined as

a number of FTEs×productive hours per day×a percentage of collections work time for outbound calls÷average collections call time.

A number of customer cleared without collections activity (calling or write-off) is defined as

a number of customers becoming past due×a percentage of past due customers paying without collections activity.

In one exemplary embodiment, for collection capacity, productive work hours/day is seven, average number of customers past due is 8343, a percentage of past due customers paying without collections activity is 64.412%, a percentage of collections work time for outbound calls is 50% and a number of calls per customer per month to clear a customer is two.

### Number of Collections FTEs

A number of collections FTEs is calculated from

a current number of collections FTEs+a maximum number of collectors added at one hiring.

In one embodiment, the number of collections FTEs is calculated as

(a number of calls per month requesting to clear customers×a total number of customers past due×an average of collections call times×a time for outbound calls×net time worked)/(a number of dates of the month×a number of productive work hours),

assuming that a maximum number of collectors added at one hiring is greater than or equal to

((a number of calls per month requesting to clear customers×a total number of customers past due×an average of collections call times×a time for outbound calls×net time worked)/(a number of dates of the month×a number of productive work hours))−a number of collections FTEs.

### Number of Adjustments FTEs

A number of adjustments FTEs is calculated as

(1+(a value of adjustments items created/an average adjustments item value)×an average adjustments action time in minutes)/(productive hours per day×60),

if a percentage volume adjustments backlog is greater than monthly adjustments backlog volume tolerance, and from a number of adjustments FTEs −1, if a percentage of volume adjustments backlog is less than or equal to a monthly adjustments backlog volume tolerance.

The adjustments FTE hiring trigger is assumed to be less than the missed tolerance if (a percentage of volume adjustments backlog is greater than allowable adjustments monthly backlog volume) OR (a percentage of volume adjustments backlog is less than 0.8×(allowable adjustments monthly backlog volume)×(adjustments FTE hiring trigger +1)),

where credit memos (CMs) backlog value is calculated as

an amount of CMs backlog+(a number of new CMs−a number of completed CMs)×average CM value.

Other adjustments backlog value is calculated as

an amount of other adjustments backlog+(a number of new other adjustments−a number of other adjustments completed)×an average adjustments item value without CMs,

where a number of new other adjustments is calculated as

a percentage adjustment created by accounts receivable error+a percentage adjustment created from other errors+a percentage adjustment created by client accounts receivable error+(1−a percentage of accounts receivable items with no error)×(a number of new manual invoices+a number of new manual payments×an average number of invoices per payment).

A total amount of an adjustments backlog is an amount of CMs backlog+an amount of other adjustments, and a percentage volume of adjustments backlog and is calculated as

a total amount of adjustments backlog÷(a total business daily volume ×a total volume from a 1^{st} Monday through a 5^{th} Tuesday)/traditional business daily volume for a 1^{st} Monday.

In one exemplary embodiment, for determining a number of adjustments FTEs, it is assumed that productive work hours/day is seven, a percentage of adjustments work actually clearing E-commerce items is 90%, a total of available hours not worked is 10%, net time worked is 90%, an average CM action time in minutes 0.4 and an average adjustments item value is $3776.00.

### Adjustments FTE Cost

If the adjustments FTE hiring trigger is less than five, adjustments FTE cost is calculated as

a number of adjustments FTEs×an average hourly wage for adjustments FTEs×7.5,

but if the adjustments FTE hiring trigger greater than or equal to 5, adjustments FTE cost is then calculated as

(a number of adjustments FTEs×an Adjustments average hourly wage×7.5)+( a number of adjustments FTEs×an Adjustments average hourly wage×7.5 ×1.5×0.4).

### Adjustments Capacity (credit memos)

If the adjustments FTE hiring trigger is less than 2, an adjustments capacity (defined as a number of credit memos completed) is calculated. A number of credit memos completed is defined as

(a number of adjustments FTEs×a percentage of adjustments work clearing E-commerce items×productive hours per day×a percentage net time worked×60×(value of credit memos backlog/(value of credit memos backlog+value of other adjustments backlog)))/an average credit memo action time in minutes.

Alternatively, if the adjustments FTE hiring trigger is greater than or equal to 2, adjustments capacity (number of credit memos completed) is calculated, where a number of credit memos completed is defined as

((1+0.4)×a percentage of adjustments work clearing E-commerce items×(number of adjustments FTEs×productive hours per day×a percentage net time worked)×60×(value of credit memos backlog/(value of credit memos backlog+value of other adjustments backlog)))/an average credit memo action time in minutes.

In one exemplary embodiment, for determining adjustments capacity for credit memos, it is assumed that productive work hours/day is seven, a percentage of adjustments work actually clearing E-commerce items is 90%, a total of available hours not worked is 10%, net time worked is 90%, an average CM action time in minutes 0.4, an average adjustments item value is $3776.00, and an average credit memo has a value of $1715.00.

### Adjustments Capacity (number of other adjustments)

An adjustments capacity (for a number of other adjustments completed items), if the adjustments FTE hiring trigger is less than 2, is calculated where a number of other adjustments completed is defined as

(a number of adjustments FTEs×a percentage of adjustments work clearing E-commerce items×productive hours per day×a percentage net time worked×60×(value of other adjustments backlog/(value of other adjustments backlog+value of credit memos backlog)))/an average adjustments action time in minutes without credit memos.

While if the adjustments FTE hiring trigger is greater than or equal to 2, a number of other adjustments completed is defined as

((1+0.4)×a percentage of adjustments work clearing E-commerce items×(number of adjustments FTEs×productive hours per day×a percentage net time worked)×60×(value of other adjustments backlog/(value of credit memos backlog+value of other adjustments backlog)))/an average adjustments action time in minutes.

In one exemplary embodiment, for determining adjustments capacity, for adjustments other than those with credit memos, it is assumed that productive work hours/day is seven, a percentage of adjustments work actually clearing E-commerce items is 90%, a total of available hours not worked is 10%, net time worked is 90%, an average adjustments action time without credit memos is 1.89 minutes, and an average adjustments item value is $3776.00.

### Number of Client services FTEs

If the funding error rate exceeds the baseline funding error rate, the number of client services FTEs required is calculated as

a number of current client services FTEs+1+0.0000477×a funding error rate.

Alternatively, if the funding error rate is less than or equal to the baseline funding error rate, a number of client services FTEs required is defined as the number of client services FTEs −1, where,

a funding error rate is greater than (baseline funding error rate×total fundings) OR the funding error rate is less than (0.8×baseline funding error rate×total fundings).

In one exemplary embodiment, for determining a number of client services FTEs required, it is assumed that a baseline funding error rate is 0.14%, a client services accuracy coefficient is 0.0000239, a non-funding client services worktime is 50% and a number of manual funding requests per 1 MM monthly volume traditional business is 12.

The number of manual funding requests is

(a total number of manual funding requests per 1 MM of monthly volume×total business daily volume×(total traditional business daily volume from first Monday through fifth Tuesday/first Monday volume))/21.6.

A funding error rate is

(a client services accuracy coefficient×a number of manual funding requests)/(a number of client services FTEs×(1−non-funding client services worktime)).

### Client Services FTE Costs

Costs, such as client services FTE costs, are determined as follows. If the client services FTE hiring trigger is less than 5, client services FTE cost is calculated as

a number of client services FTEs×an average hourly wage in client bervices×7.5,

where, if the client services FTE hiring trigger is greater than or equal to 5,

client services FTE cost=number of client services FTEs×an average hourly wage in client services×7.5×(1+0.4×1.5),

and all costs are determined according to analogous equations.

If the funding error rate is greater than baseline funding error rate (total fundings), then number client services FTEs is defined as

a number of client services FTEs+1 +0.0000477×a funding error rate.

However, if the funding error rate is less than or equal to baseline funding error rate (total fundings), then a number of client services FTEs is defined as a number of client services FTEs−1.

To implement the processes and capacity calculations described above, many variations of particular spreadsheets and reports can be utilized. The following description refers to one set of spreadsheets and reports that can be used to prompt a user to input information pertaining to independent variables for the base model and to display an output of dependent variables from the operations modeling system for the base model. Further, a user is able to determine, by varying input variables, for example, capacity, in the form of a percentage annual increase in volume, to determine when a capacity of the existing staff of FTEs will be exceeded, resulting in a need to add one or more FTEs.

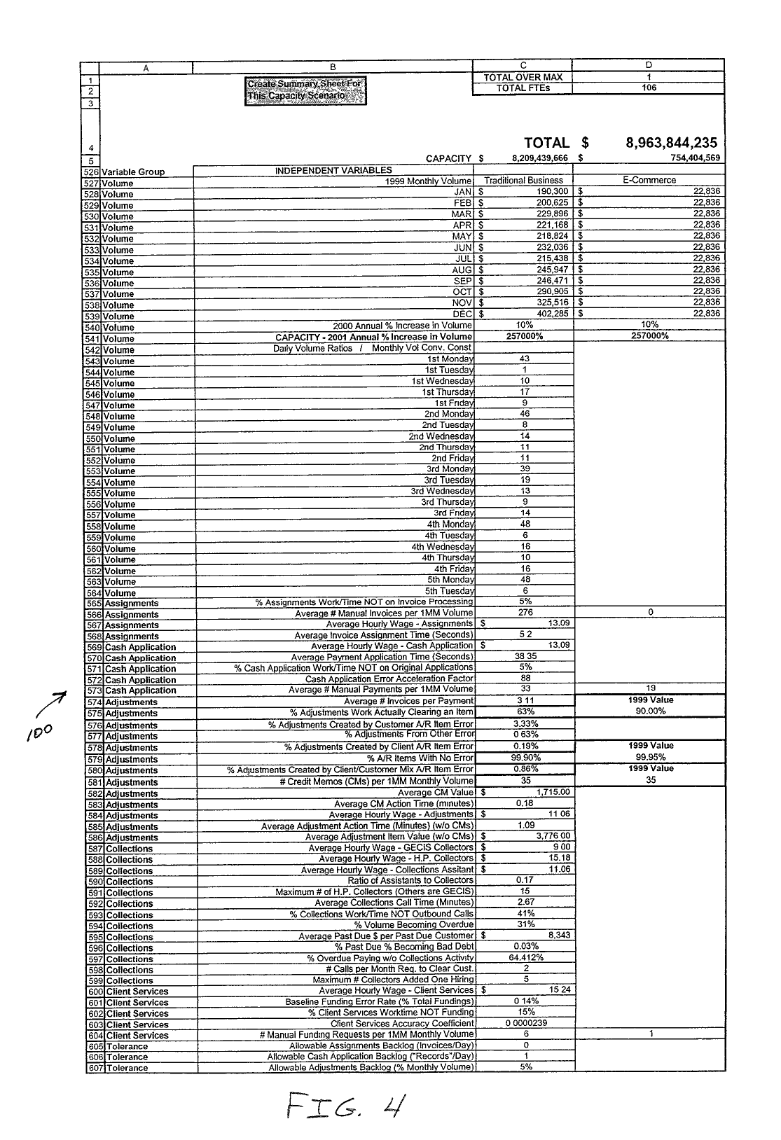

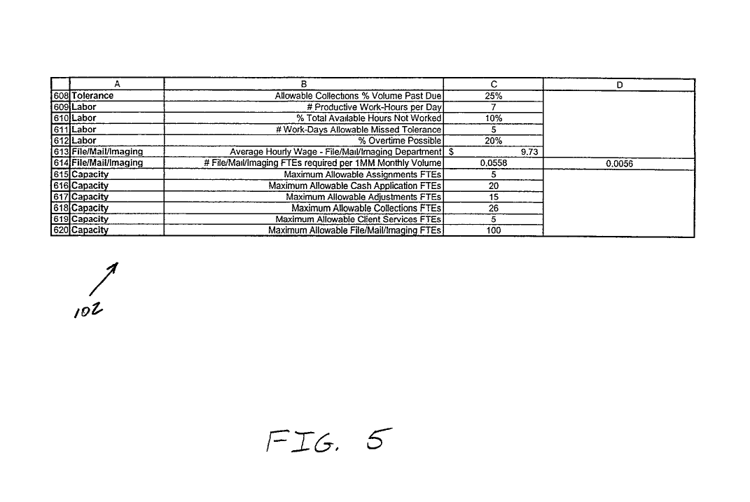

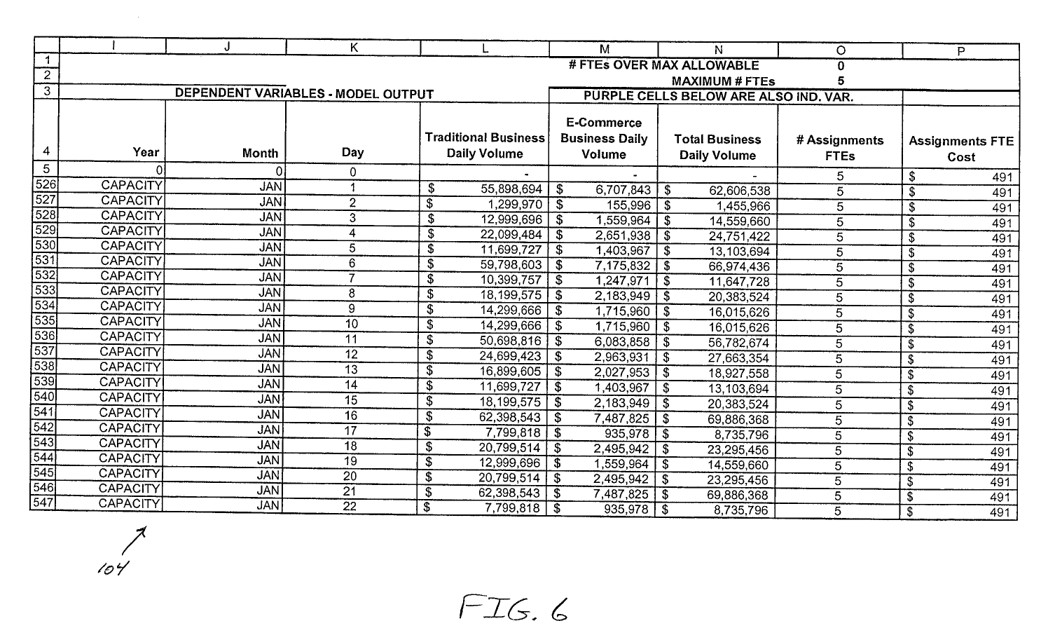

Of course many variations of such spreadsheets are possible. Referring now again specifically to the drawings, FIGS. 4 and 5 are spreadsheets containing a plurality of independent variables, used as inputs to an operations simulation. FIGS. 6 through 11 are reports that display an output of the dependent variables which result from the simulation.

FIG. 4 is a spreadsheet 100 and FIG. 5 is a continuation spreadsheet 102 according to one embodiment of the present invention. The spread sheets are stored within system 10 (shown in FIG. 1) and contain data entry fields for independent variables used in modeling the operations of a financial services business. Examples of independent variables shown in FIG. 4 include those relating to volume, assignments, cash application, adjustments, collections, client services, tolerance, labor, file/mail/imaging, and capacity.

More specifically, volume data input to system 10 include monthly volume, the months of the year (January, February, March, April, May, June, July, August, September, October, November, December), the annual increase in volume for a year, daily volume ratios/monthly volume conversion constant, and the volume for a given day of the month. In an exemplary embodiment, the given days of the month are at least one of a 1st Monday, a 1st Tuesday, a 1st Wednesday, a 1st Thursday, a 1st Friday, a 2nd Monday, a 2nd Tuesday, a 2nd Wednesday, a 2nd Thursday, a 2nd Friday, a 3rd Monday, a 3rd Tuesday, a 3rd Wednesday, a 3rd Thursday, a 3rd Friday, a 4th Monday, a 4th Tuesday, a 4th Wednesday, a 4th Thursday, a 4th Friday, a 5th Monday, and a 5th Tuesday.

Assignments data include a percentage of work/time not on invoice processing, an average number of manual invoices per 1 MM volume, an average hourly wage—assignments, and an average invoice assignment time in seconds.

Cash application data include average hourly wage—cash application, average payment application time, percent cash application work/time not on original applications, cash application error acceleration factor, and average number of manual payments per dollar volume.

Adjustments data include average number of invoices per payment, percent adjustments work actually clearing an item, percent adjustments created by customer accounts receivable item error, percent adjustments from other error, percent adjustments created by client accounts receivable item error, percent accounts receivable items with no error, percent adjustments created by client/customer mix accounts receivable item error, number of credit memos per dollar monthly volume, average cm value, average cm action time, average hourly wage—adjustments, average adjustment action time, and average adjustment item value.

Collections data include average hourly wage—collectors, average hourly wage—collections assistant, ratio of assistants to collectors, maximum number of collectors, average collections call time, percent collections work/time not outbound calls, percent volume becoming overdue, average past due sum per past due customer, percent past due percent becoming bad debt, percent overdue paying without collections activity, number of calls per month required to clear customer, and maximum number of collectors added in one hiring.

Client services data include average hourly wage—client services, baseline funding error rate (percent total fundings), percent client services worktime not funding, client services accuracy coefficient, and number of manual funding requests per dollar monthly volume.

Tolerance data include allowable assignments backlog (invoices/day), allowable cash application backlog (records/day), allowable adjustments backlog (percent monthly volume), and allowable collections percent volume past due.

Labor data include number of productive work-hours per day, percent total available hours not worked, number of workdays allowable missed tolerance, percent overtime possible.

File/mail/imaging data include average hourly wage—file/mail/imaging department and number of file/mail/imaging FTEs required per dollar monthly volume.

Capacity data include maximum allowable assignments FTEs, maximum allowable cash application FTEs, maximum allowable adjustments FTEs, maximum allowable collections FTEs, maximum allowable client services FTEs, and maximum allowable file/mail/imaging FTEs.

Spread sheet 100 further includes a scenario run button 102, which a user selects in order to generate a scenario summary report as displayed in FIGS. 6 through 11.

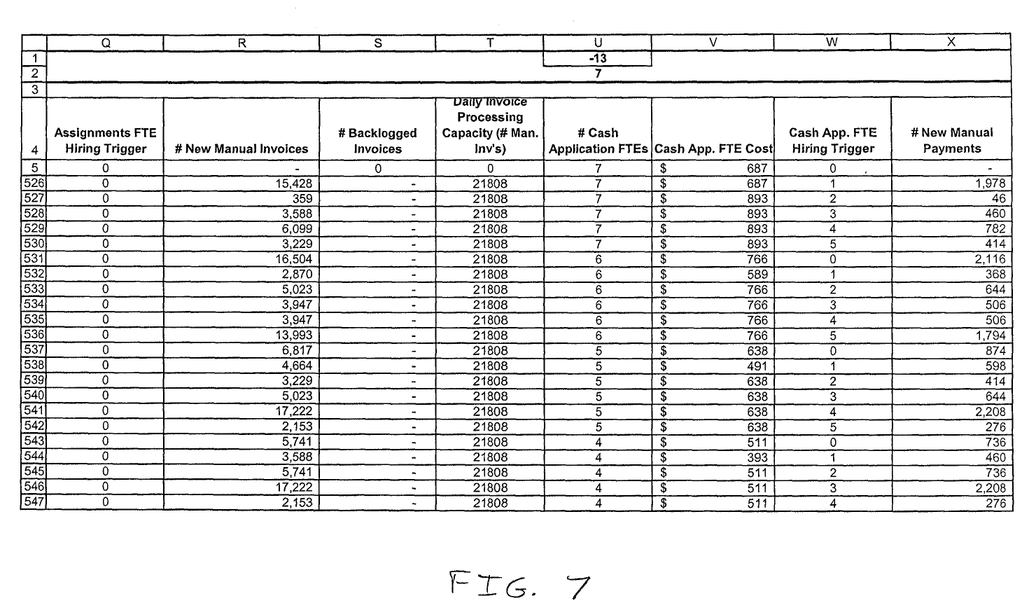

FIG. 6 is a scenario summary report 104 which includes dependent variable outputs resulting from independent variable inputs into the base model. Dependent variables displayed are calculated from the independent variables introduced as input to system 10 in FIG. 4 and FIG. 5. FIGS. 7 through 11 are continuations of scenario summary report 104.

Scenario summary report 104 includes a column each for year, month, and work day of the month. For each work day there is, a traditional business daily volume, e-commerce business daily volume, total business daily volume, number of assignments FTEs, and assignments FTEs cost. Further, and as displayed in report 104, a maximum number of assignments FTEs is given along with a determination of the number of assignments FTEs over the maximum allowable number of assignments FTEs needed to complete the volume of work in the scenario. Report 104 indicates that in the scenario presented, there is a maximum of five assignments employees. The maximum number may be set based on any number of conditions, for example, budget and office space. FIGS. 7 through 11 continue presenting the analysis of the base model in report form.

FIG. 7 is an exemplary embodiment of a continuation of report 104 displaying various dependent variables in a column format FIG. 7 includes a column for each of an assignments FTEs hiring trigger, a number of new manual invoices, a number of backlog invoices, a daily invoice processing capacity (number of manual invoices), a number of cash application FTEs, a cash application FTEs cost, a cash application FTEs hiring trigger, and a number of new manual payments. Further, and as shown in FIG. 7, a maximum number of cash applications FTEs is given along with a determination of the number of cash applications FTEs over the maximum allowable number of cash applications FTEs needed to complete the volume of work in the scenario. In the scenario presented, there are currently seven cash applications FTEs, and capacity for twenty (20) cash applications FTEs, therefore a number of cash applications FTEs over the maximum allowable is negative thirteen (−13).

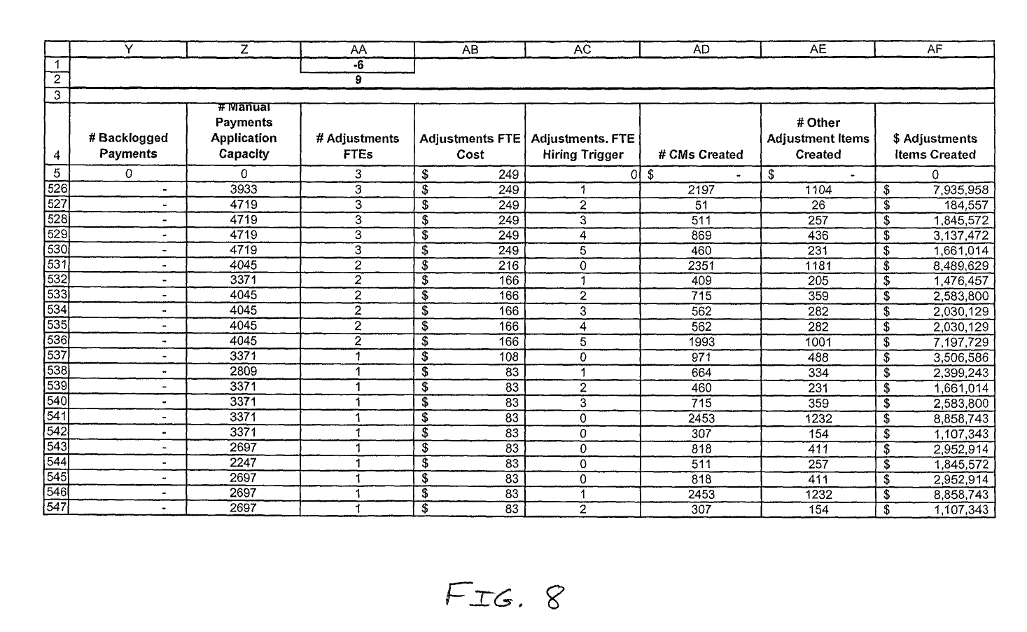

FIG. 8 is an exemplary embodiment of a continuation of report 104 displaying various dependent variables in a column format FIG. 8 includes a column for each of a number of backlogged payments, a manual payments application capacity in number of payments, a number of adjustments FTEs, adjustments FTE cost, an adjustments FTEs hiring trigger, a number of credit memos created, a number of other adjustment items created, and a dollar value of adjustment items created. Further, and as shown in FIG. 8, a maximum number of adjustments FTEs is given along with a determination of the number of adjustments FTEs over the maximum allowable number of adjustments FTEs needed to complete the volume of work in the scenario. In the scenario presented, there are currently nine adjustments FTEs, and capacity for fifteen (15) adjustments FTEs, therefore a number of adjustments FTEs over the maximum allowable is negative six (−6).

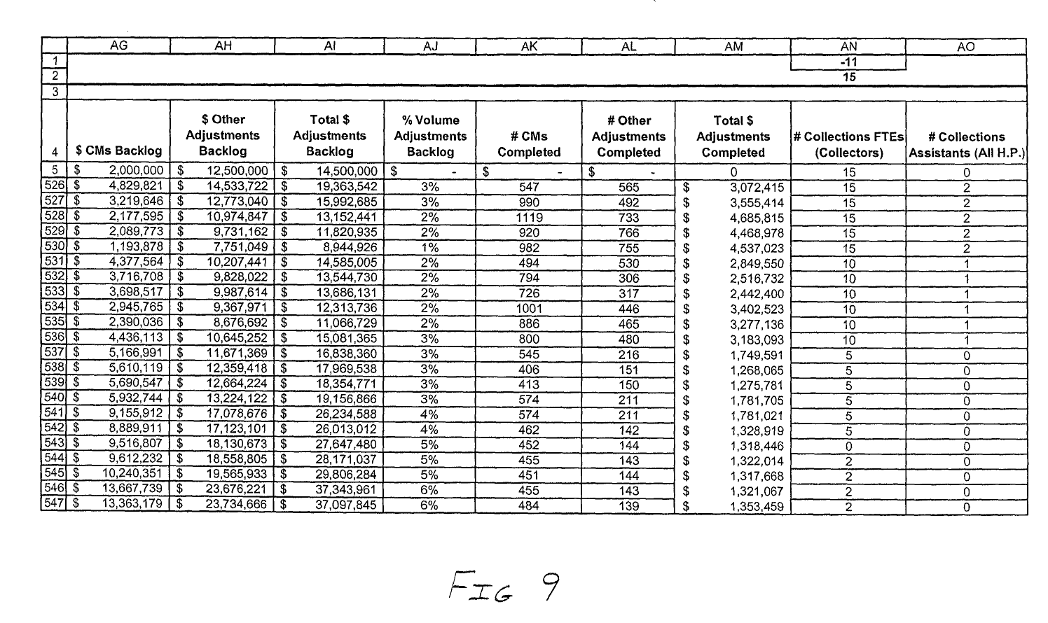

FIG. 9 is an exemplary embodiment of a continuation of report 104 displaying various dependent variables in a column format FIG. 9 includes a column for each of an amount of credit memos backlog, an other adjustments backlog, a total dollar value the adjustments backlog, a percent volume adjustments backlog, a number of credit memos completed, a number of other adjustments completed, a total dollar value of adjustments completed, a number of collections FTEs, and a number of collections assistants. Further, and as shown in FIG. 9, a maximum number of collections FTEs is given along with a determination of the number of collections FTEs over the maximum allowable number of collections FTEs needed to complete the volume of work in the scenario. In the scenario presented, there are currently fifteen (15) collections FTEs, and capacity for twenty-six (26) collections FTEs, therefore a number of collections FTEs over the maximum allowable is negative eleven (−11).

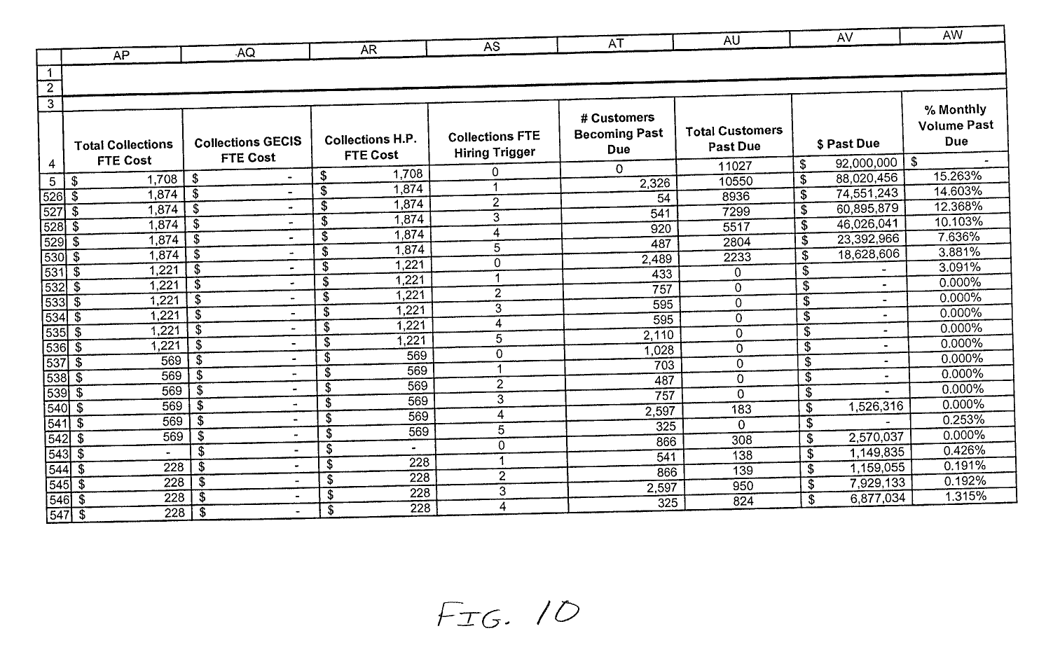

FIG. 10 is an exemplary embodiment of a continuation of report 104 displaying various dependent variables in a column format FIG. 10 includes a column for each of a total collections FTEs cost, a collections GECIS FTE cost, a collections H.P. FTE cost, a number of customer is becoming past due, a total customers past due, a dollar value of past due accounts, and a percent monthly volume that is past due.

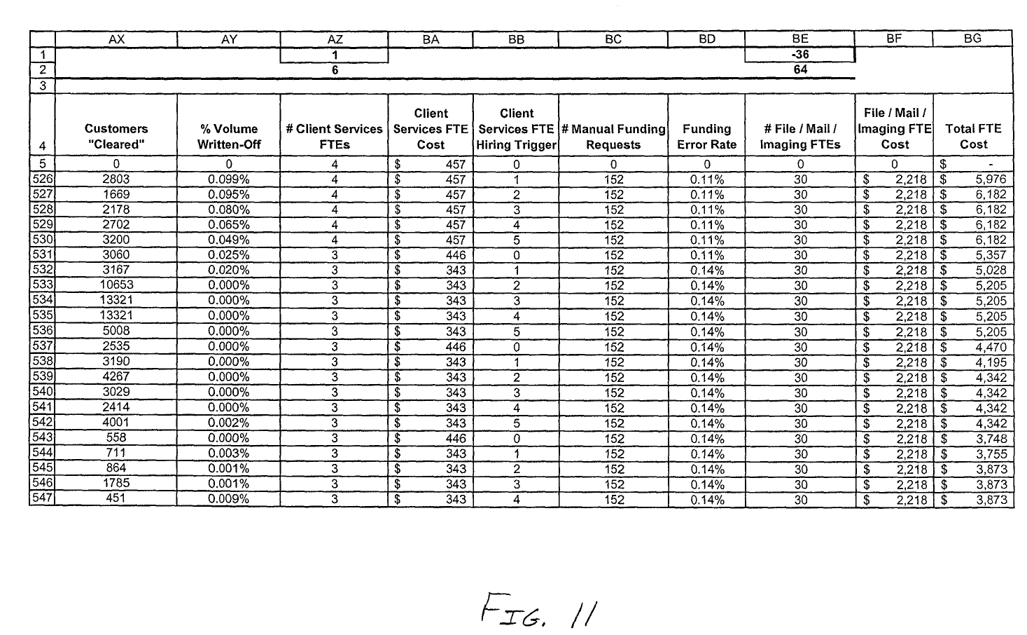

FIG. 11 is an exemplary embodiment of a continuation of report 104 displaying various dependent variables in a column format FIG. 11 includes a column for each of customers “cleared”, a percent volume written off, a number of client services FTEs, a client services FTEs cost, a client services FTEs hiring trigger, a number of manual funding requests, a finding error rate, a number of file/mail/imaging FTEs, a file/mail/imaging FTE cost, and a total FTE cost. Further, and as shown in FIG. 11, a maximum number of client services FTEs is given along with a determination of the number of client services FTEs over the maximum allowable number of client services FTEs needed to complete the volume of work in the scenario. In the scenario presented, there are currently six (6) client services FTEs, and capacity for five (5) collections FTEs, therefore one more client services FTEs is required to complete the work volume than the maximum allowable number of client services FTEs.

Also shown in FIG. 11 a maximum number of file/mail/imaging FTEs is given along with a determination of the number of file/mail/imaging FTEs over the maximum allowable number of file/mail/imaging FTEs needed to complete the volume of work in the scenario. In the scenario presented, there are currently twenty-eight (28) collections FTEs, and capacity for sixty-four (64) file/mail/imaging FTEs, therefore a number of file/mail/imaging FTEs over the maximum allowable is negative thirty-six (−36).

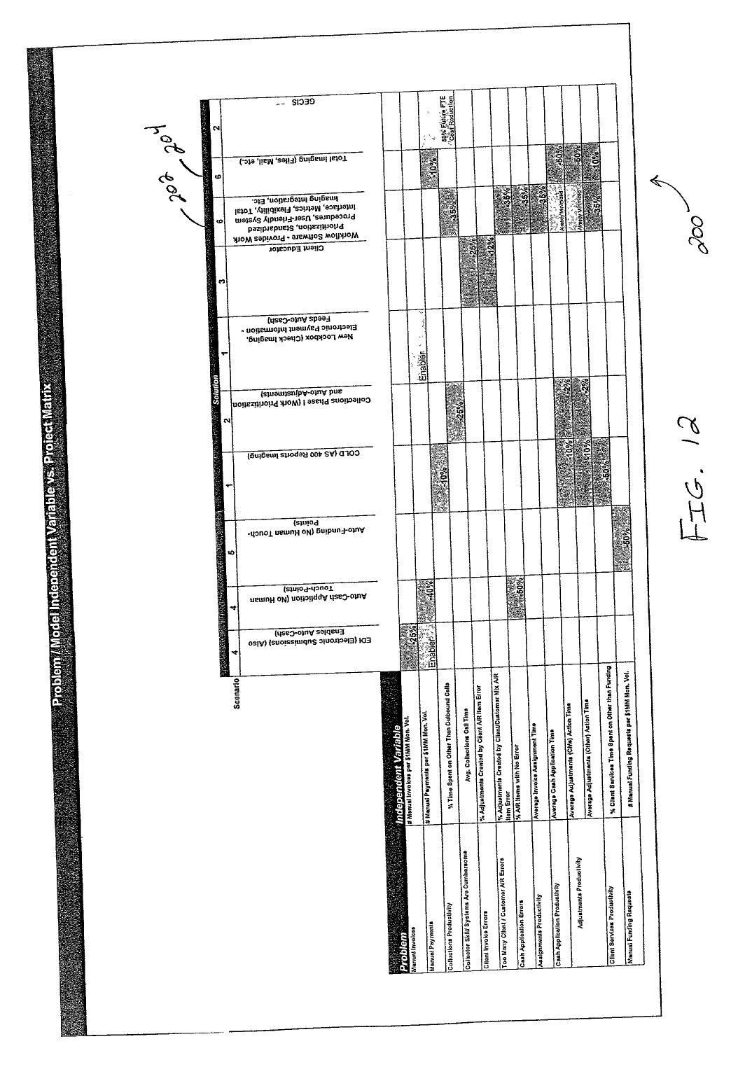

FIG. 12 is an exemplary embodiment of a chart 200, displayed in a graphical format, which is a graph of problems against scenarios intended to solve the problems. For example, one problem identified in the financial collections business is manual invoices. One independent variable which is related to manual invoices is a number of manual invoices per 1 MM monthly volume, which is an assignments independent variable and shown in FIG. 4. One scenario, labeled in FIG. 12 as scenario 4, decreases the number of manual invoices per 1 MM monthly volume by 25 percent. By running such a scenario, a user can determine a ripple effect on business operations and capacity which results in a scenario summary report, similar to report 104, shown in FIGS. 6 through 11. As shown in chart 200, a number of scenarios can be created where one or more independent variables are adjusted, and scenarios are run to determine an affect on business operations and capacity. Although chart 200 includes six scenarios, system 10 is not so limited.

Also as shown in chart 200 a scenario is a response to a business operations problem, separate solutions are employed within a scenario to determine effect on the business related problems. For example, there is shown in chart 200, two separate solutions to a scenario labeled as scenario 6. A first solution 202 adjust independent variables average collections call time, percent accounts receivable items with no error, average invoice assignment time, average cash application time, and percent client services time spent on other than funding. A second solution 204 to scenario six adjusts the independent variables percent time spent on other than outbound calls, average adjustments (credit memos) action time, average adjustments (other) action time, and percent client services time spent on other than funding.

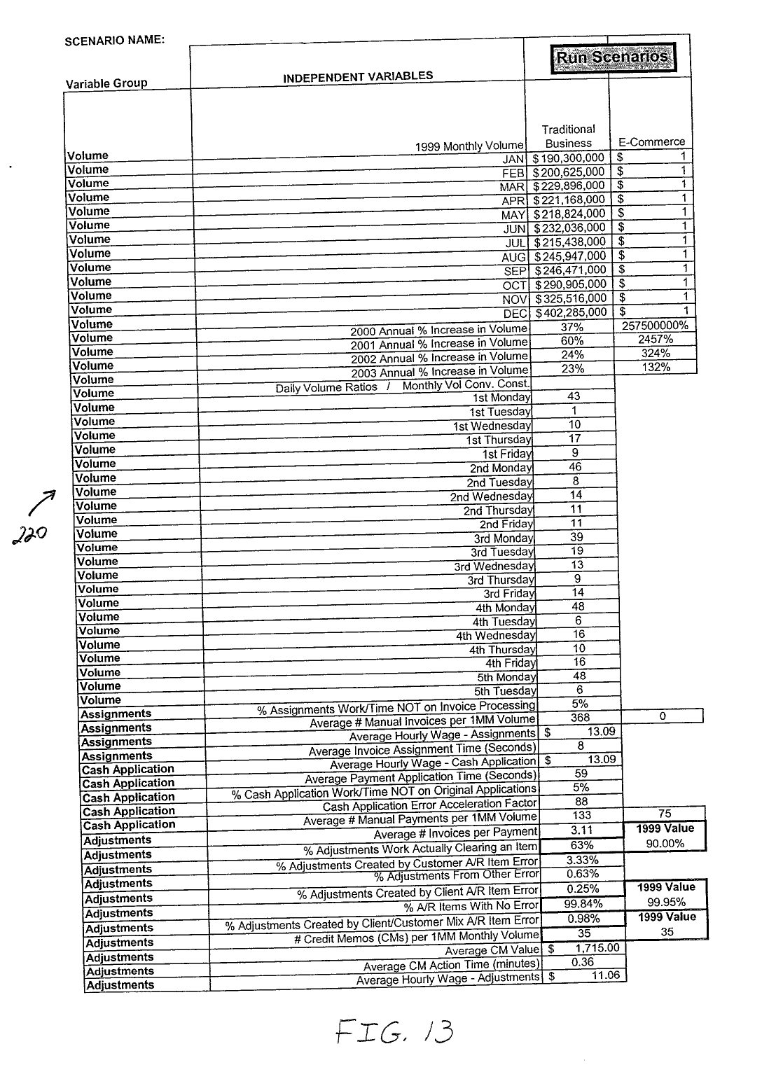

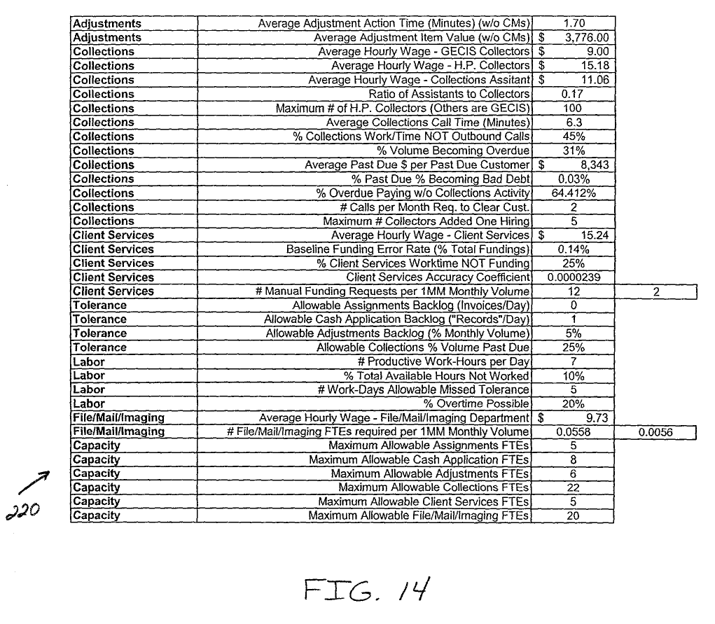

FIGS. 13 and 14 are a spreadsheet 220 where multiple independent variables have been adjusted in order to create a new scenario. Spreadsheet 220 includes the independent variables as in spreadsheet 100 (shown in FIGS. 4 and 5). The independent variables adjusted in spreadsheet 220 are not necessarily the same independent variables described as being adjusted for generating scenarios as described in chart 200 (shown in FIG. 12).

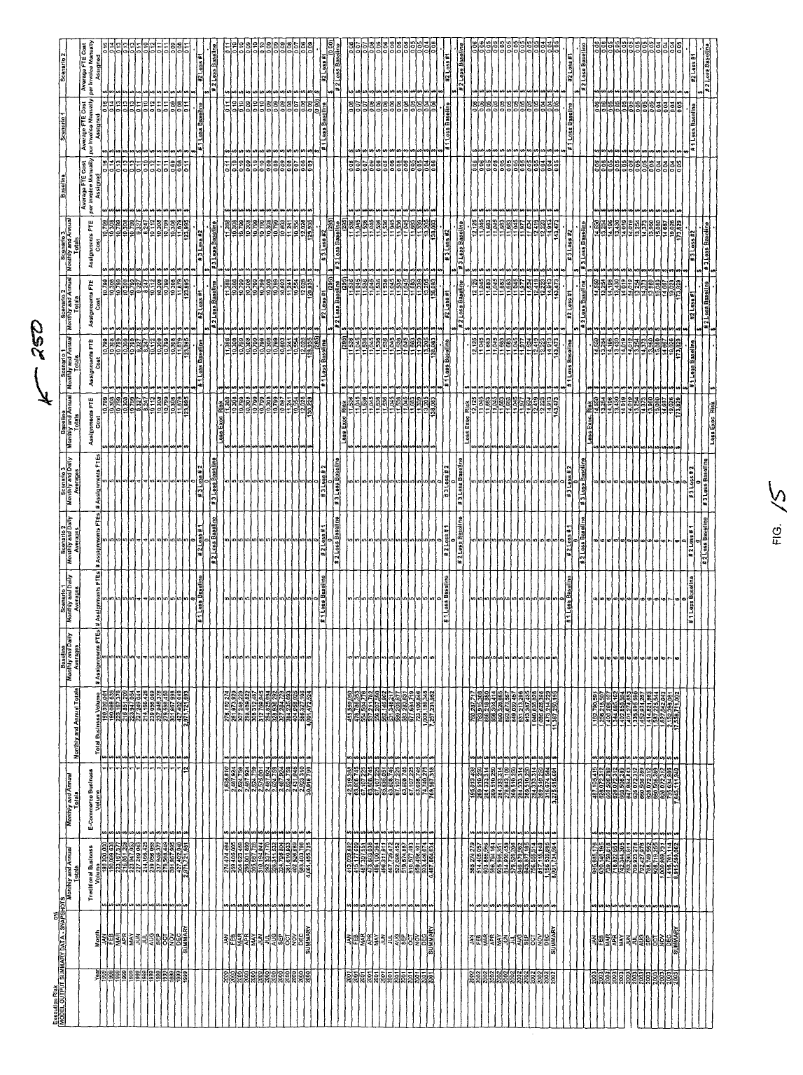

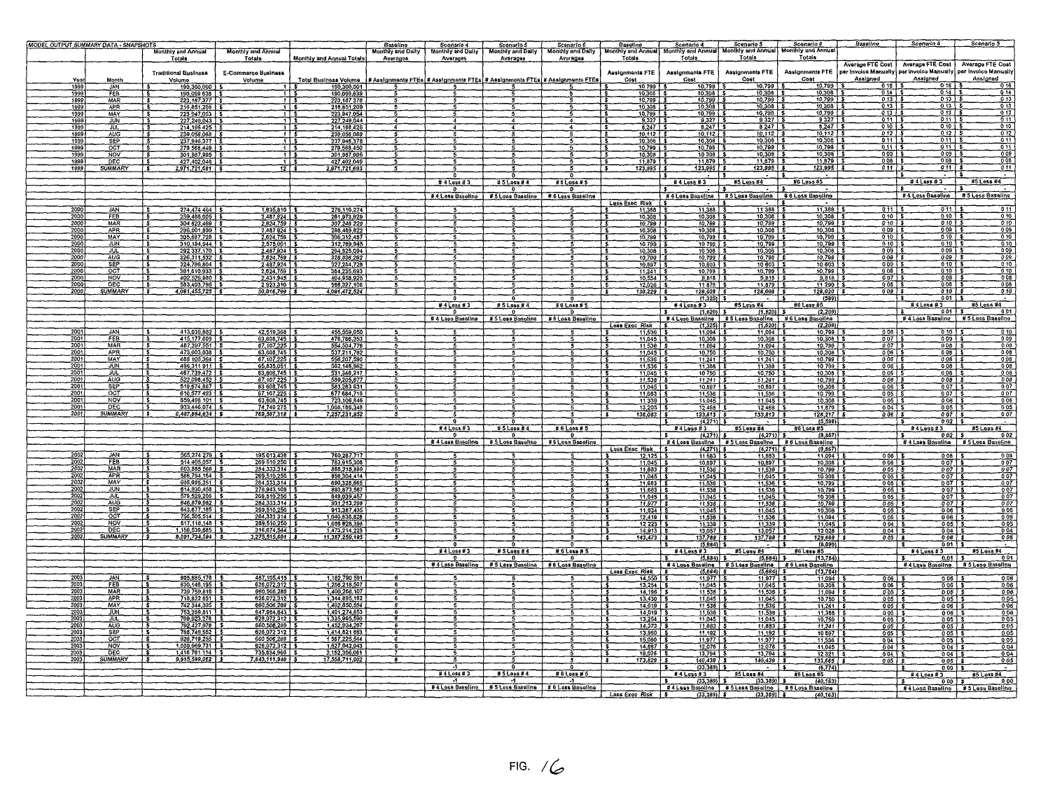

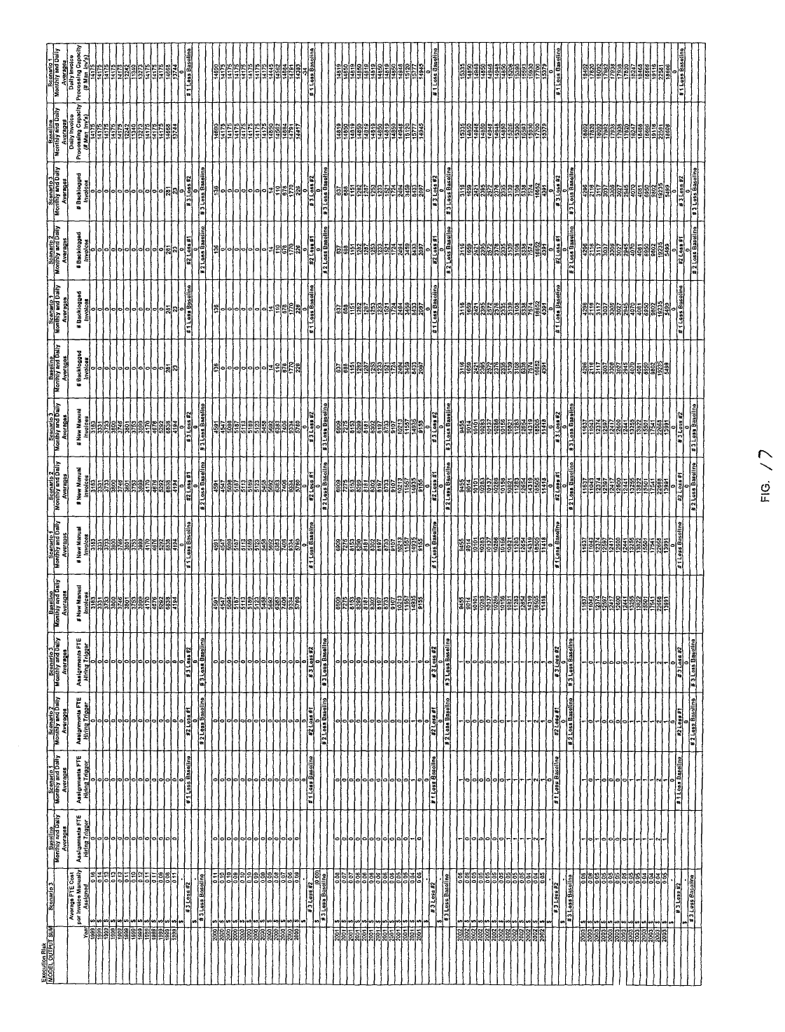

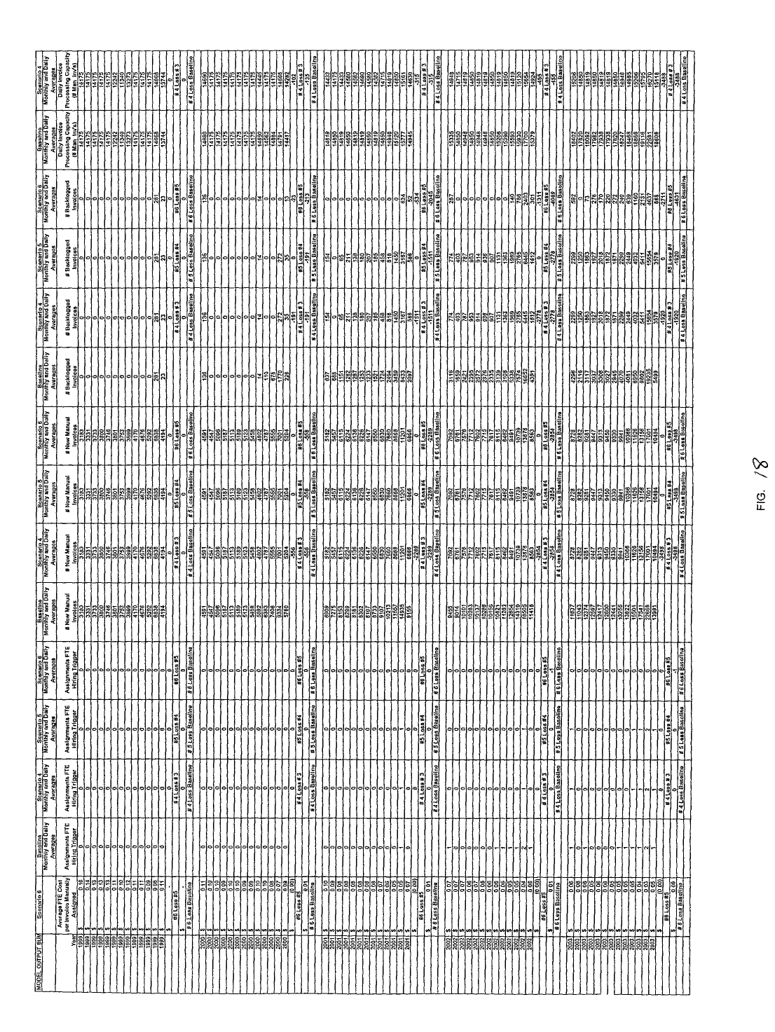

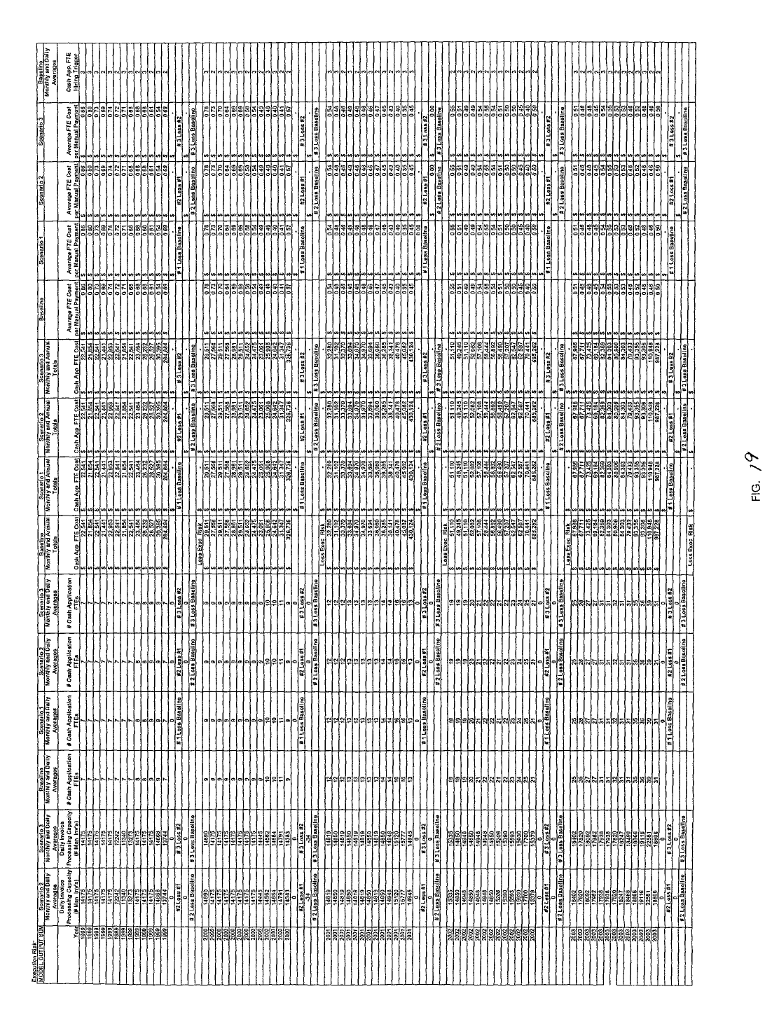

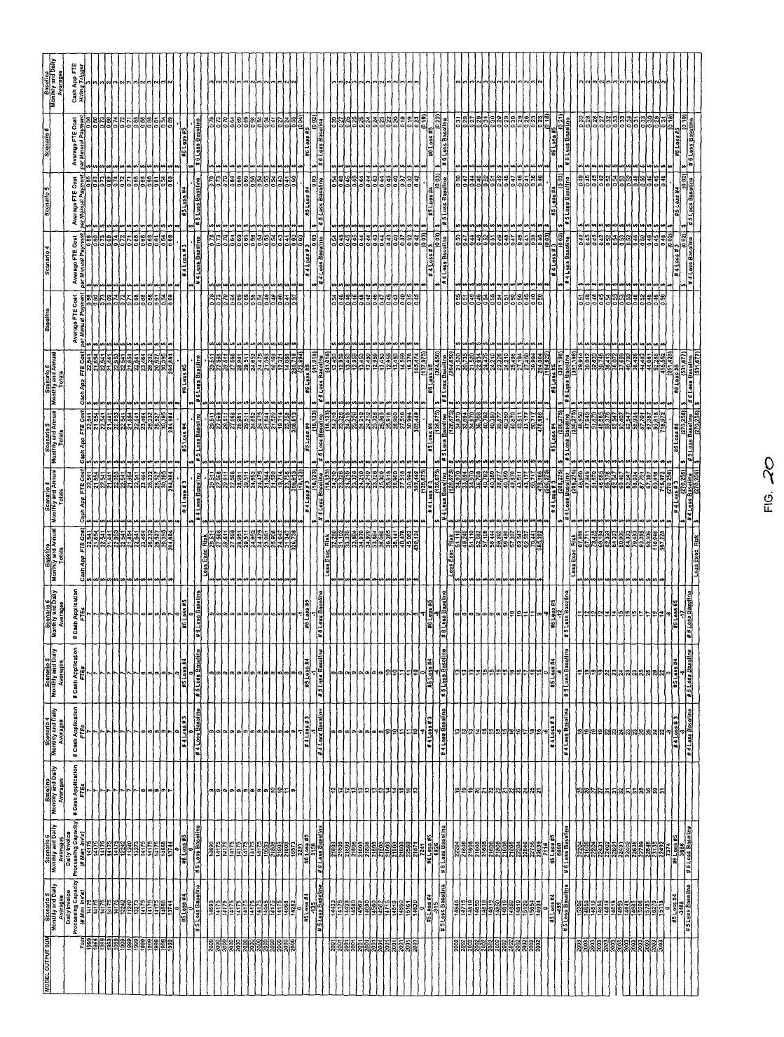

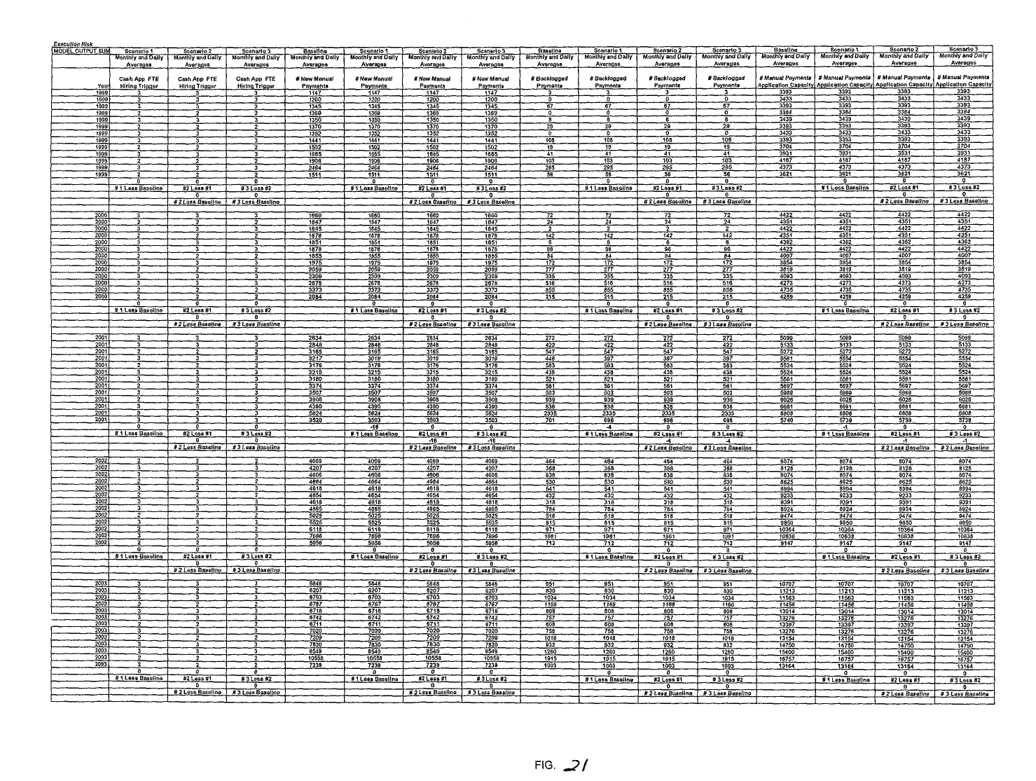

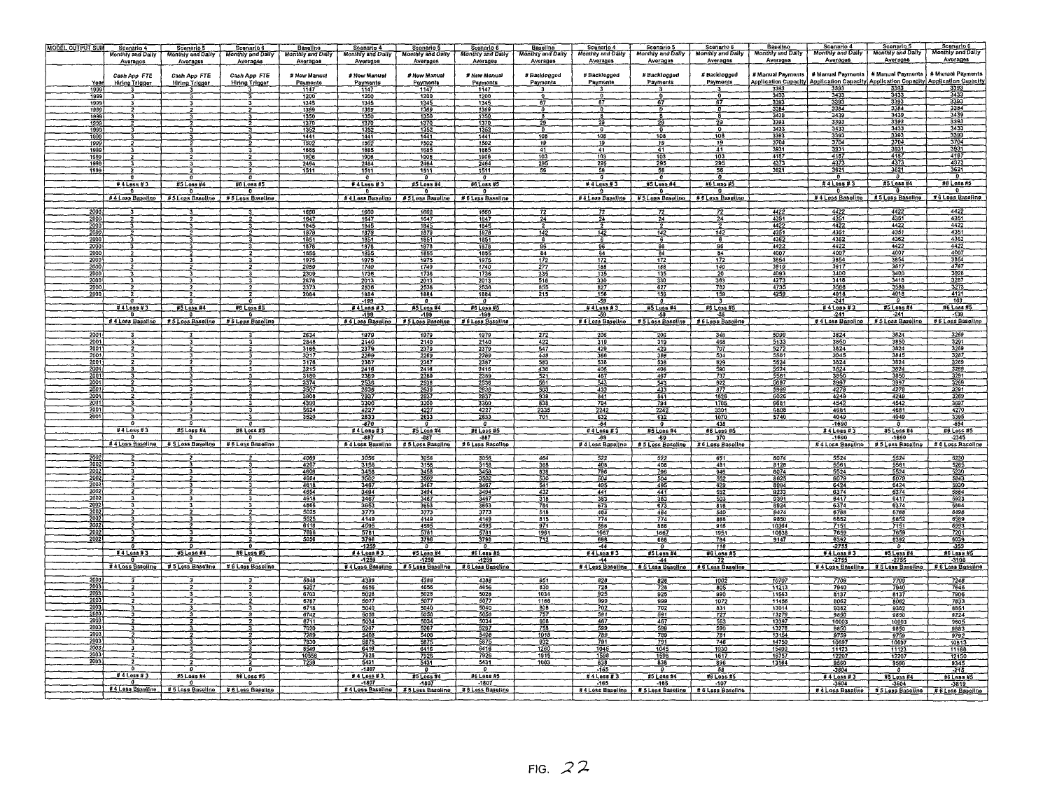

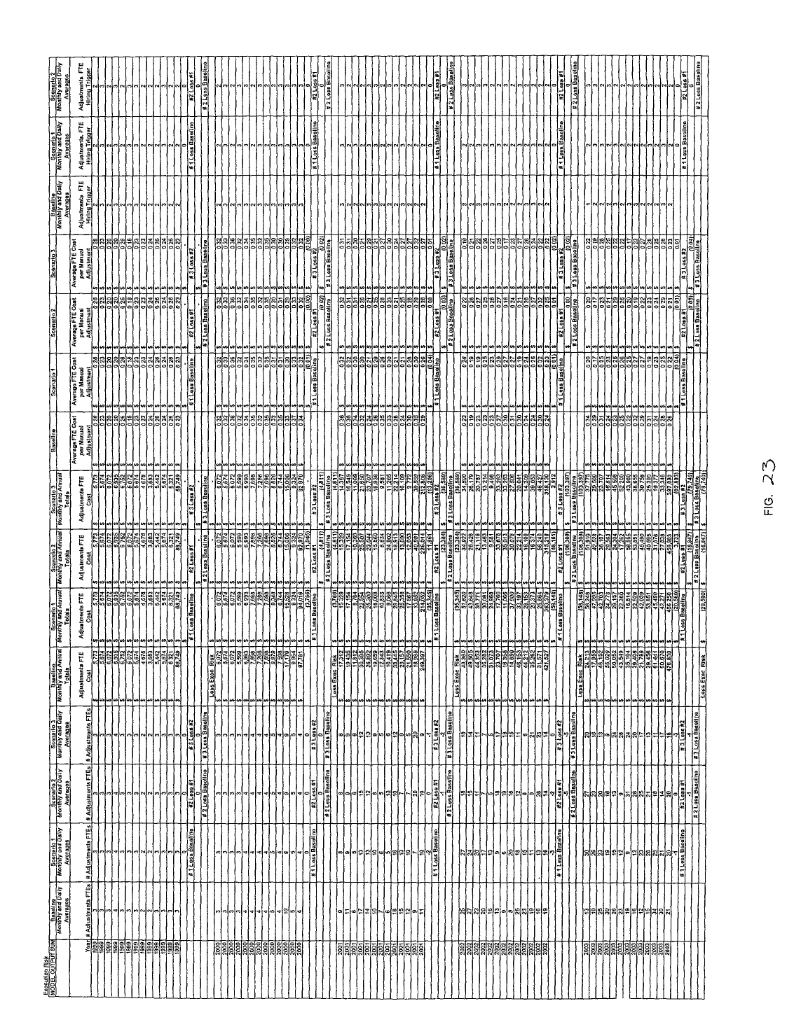

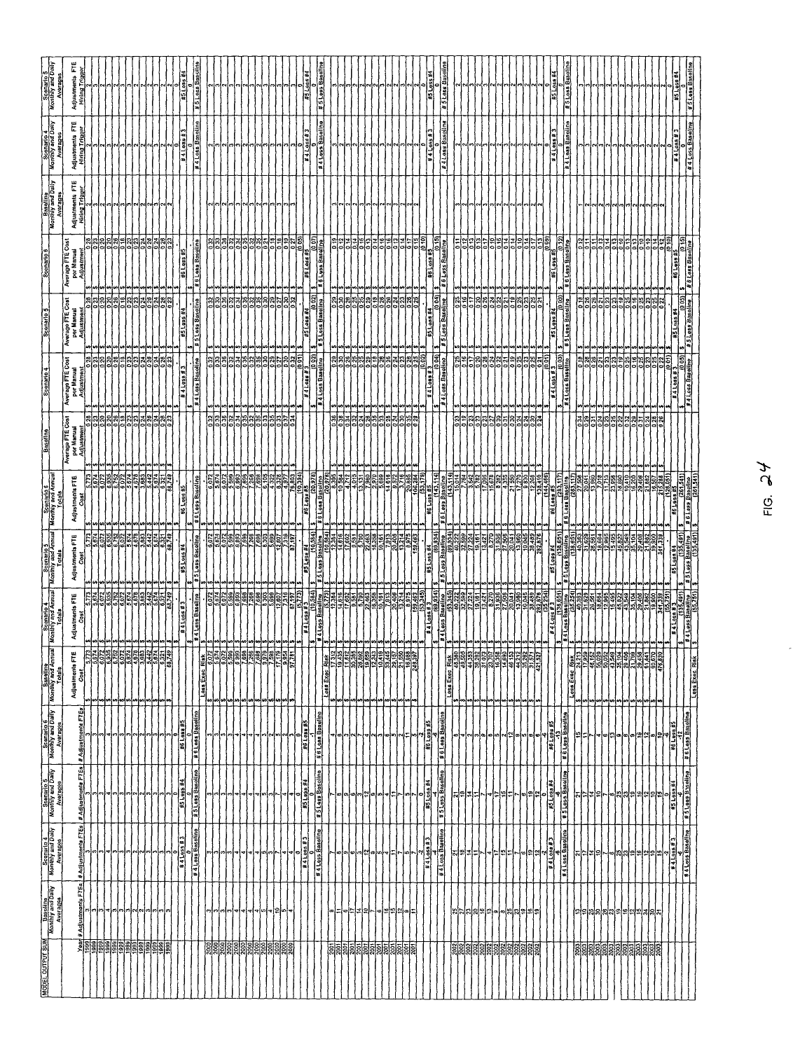

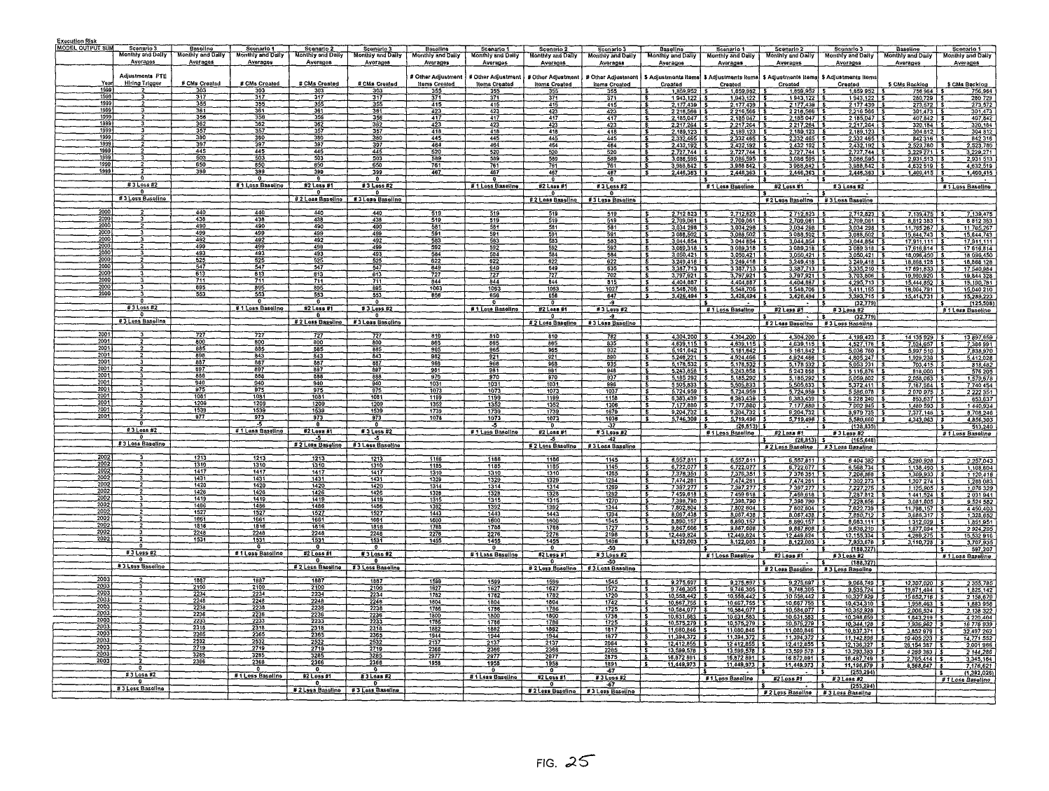

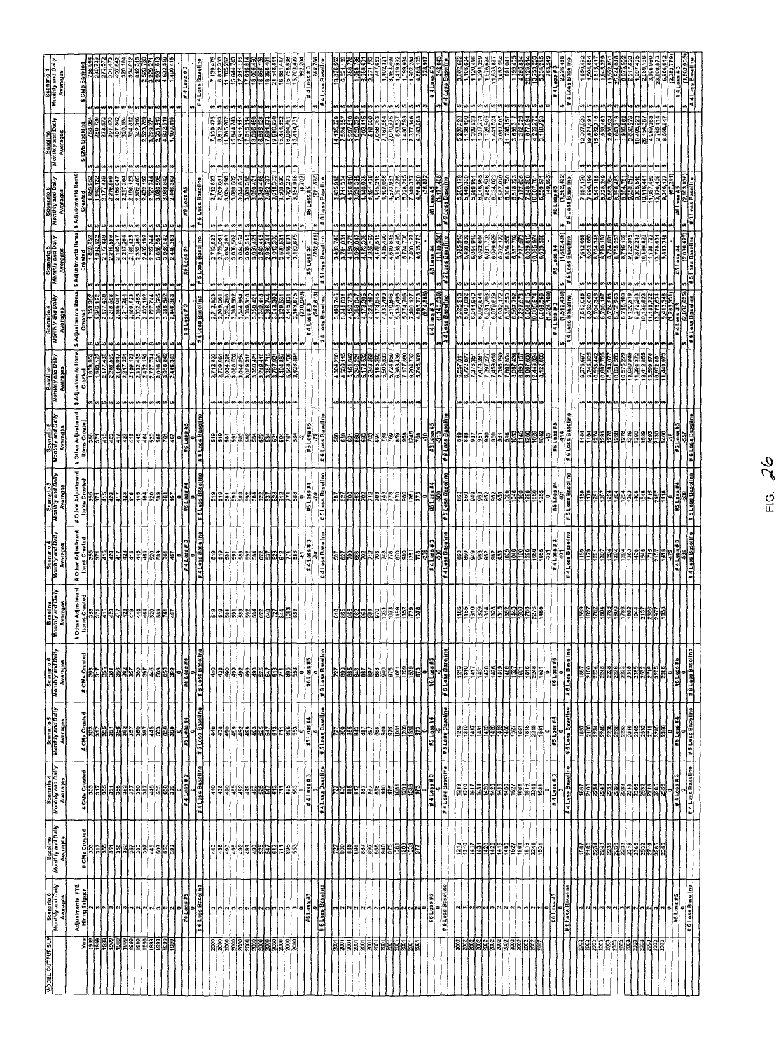

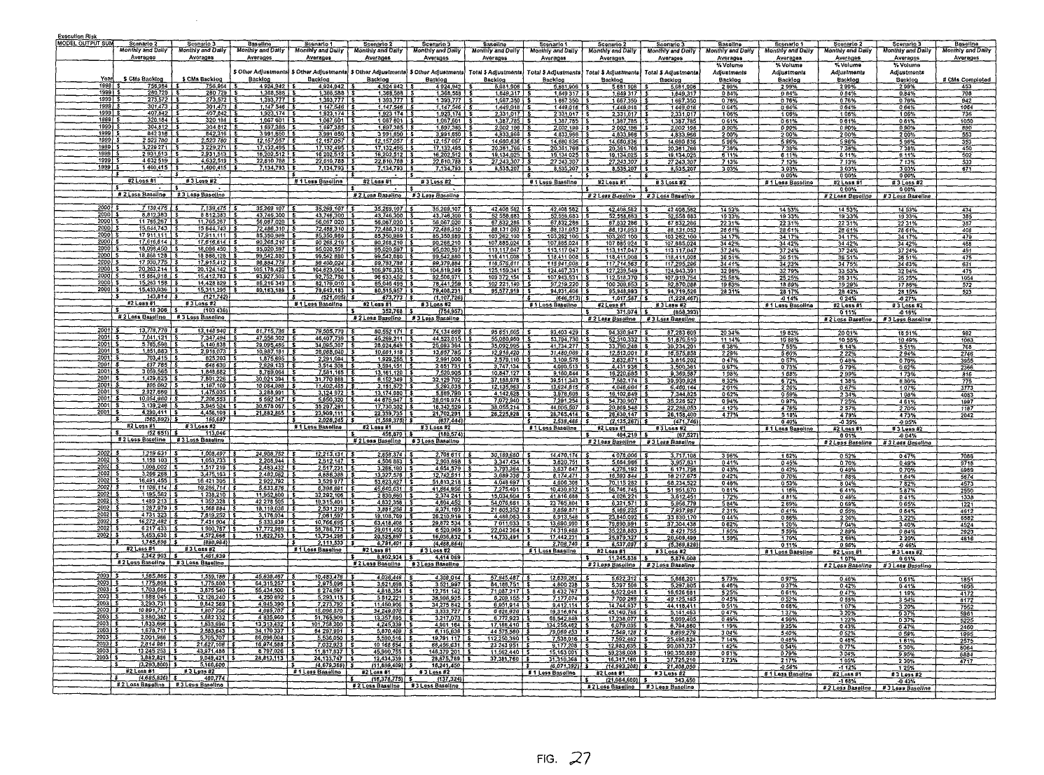

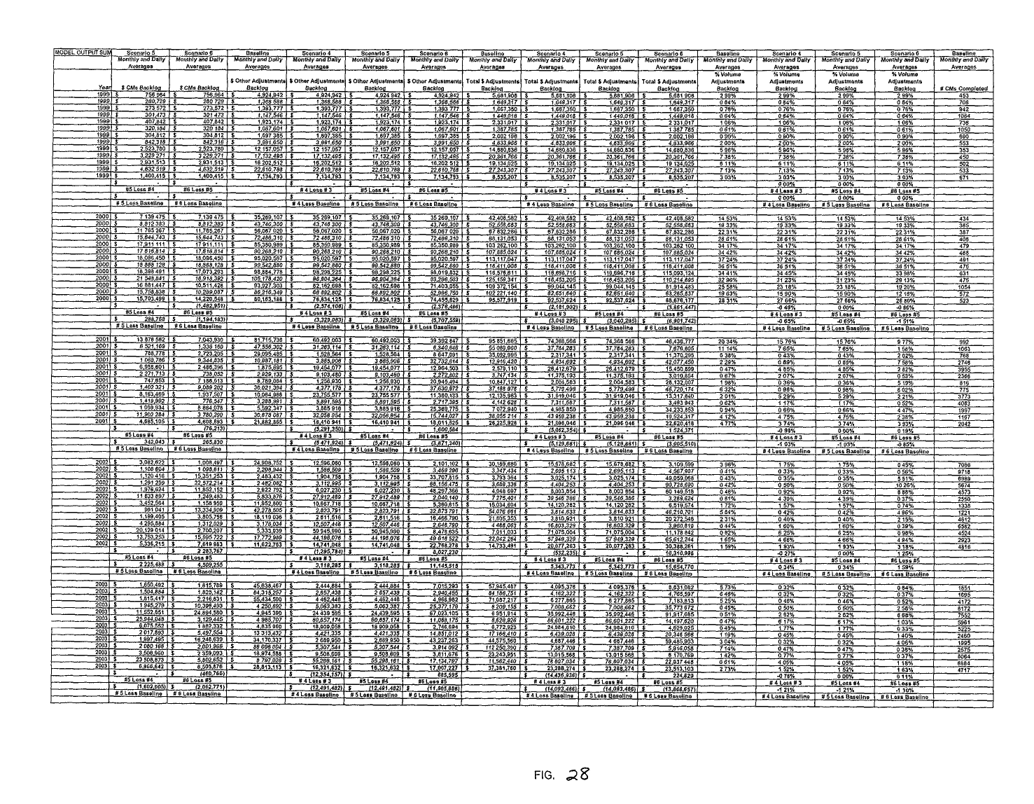

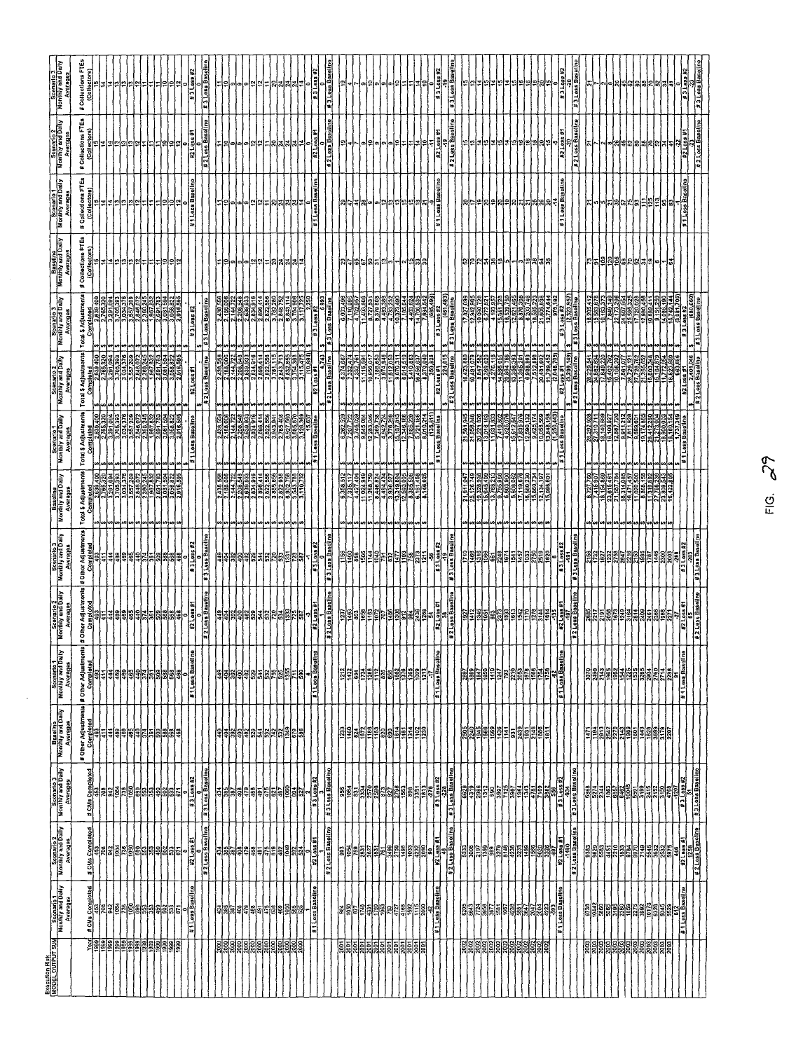

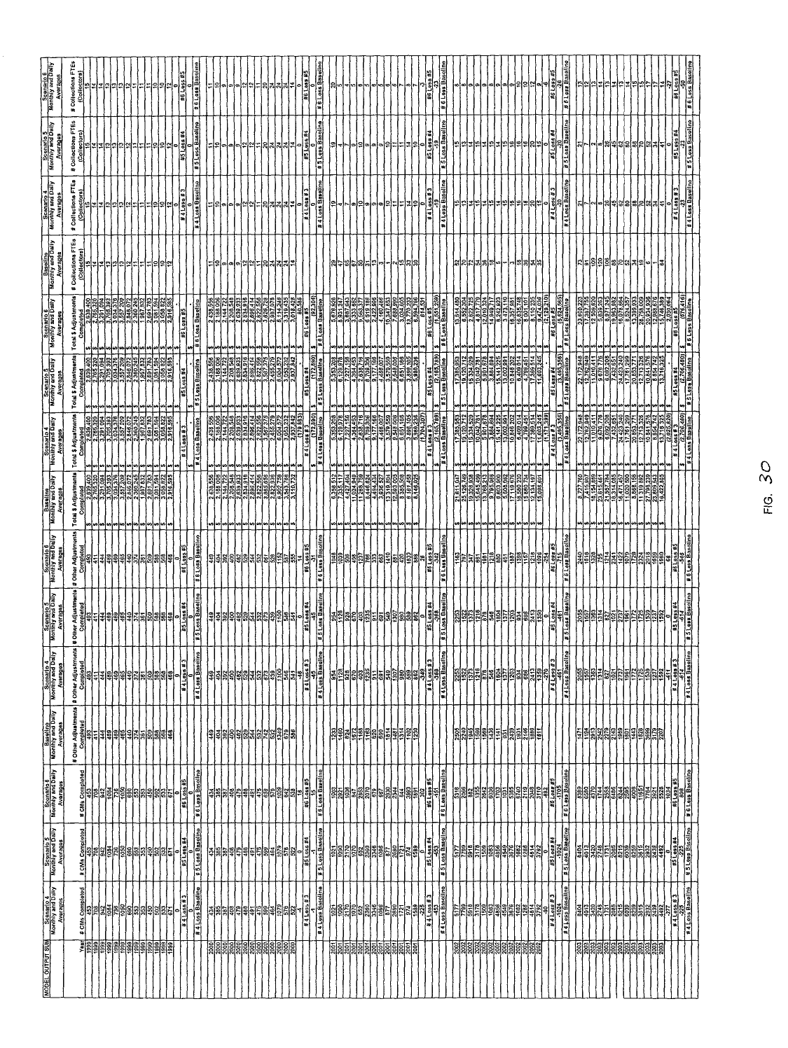

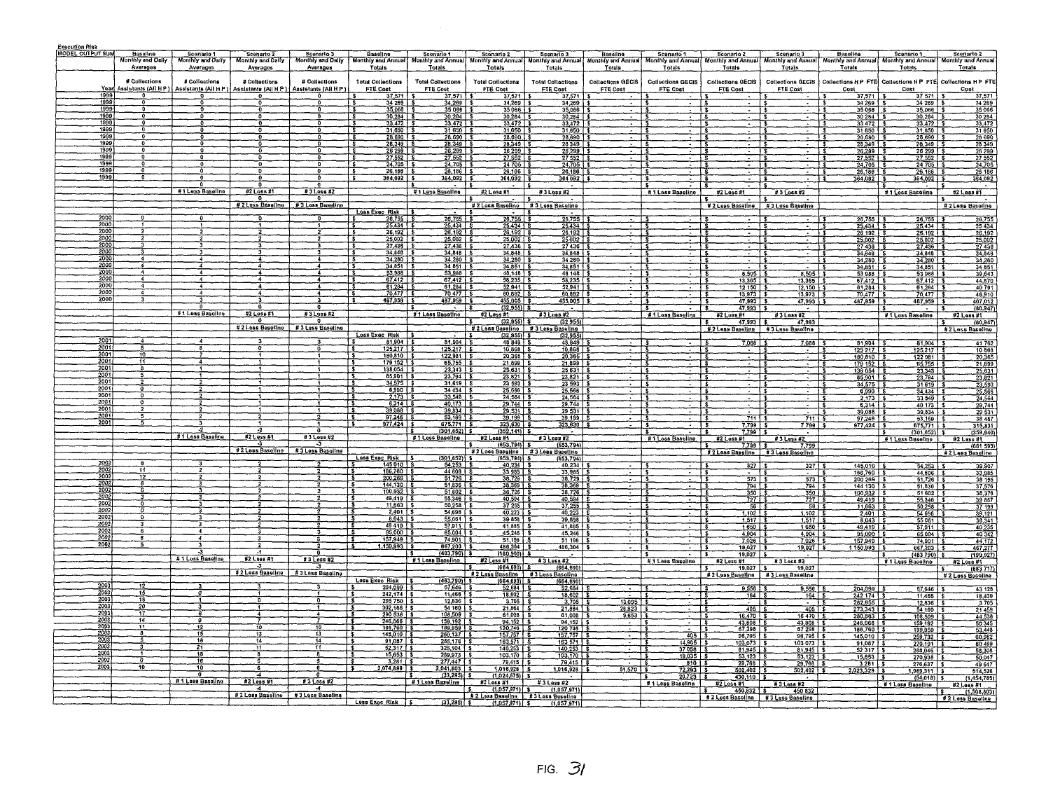

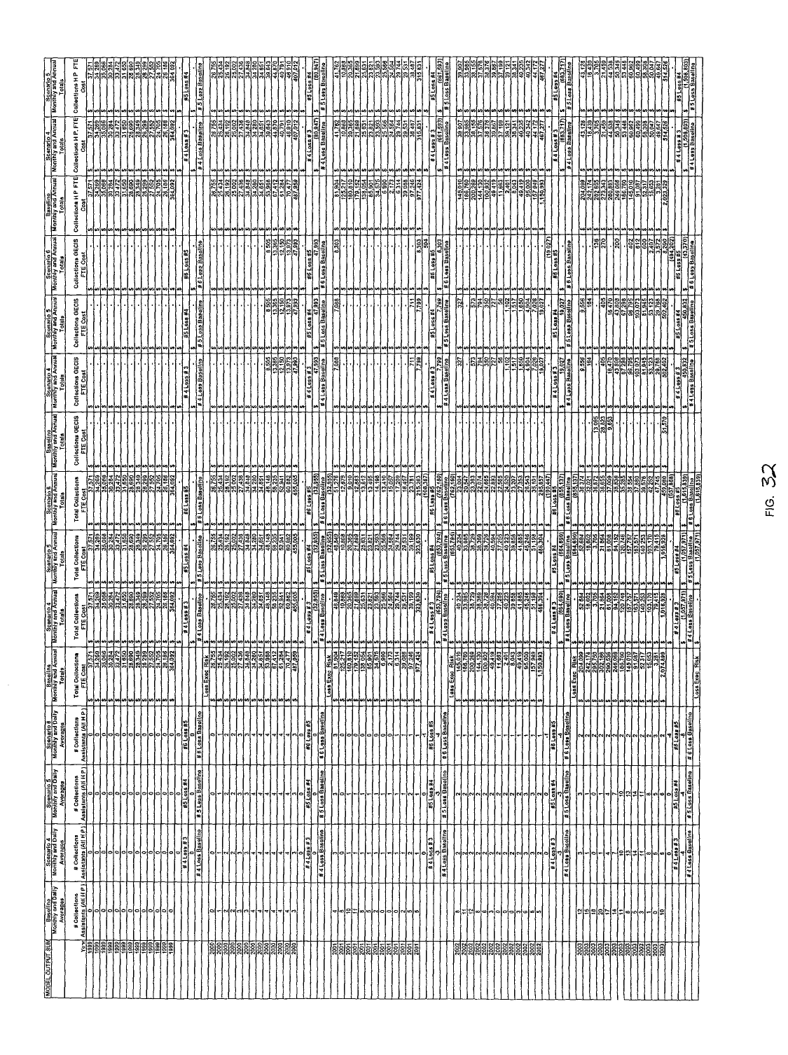

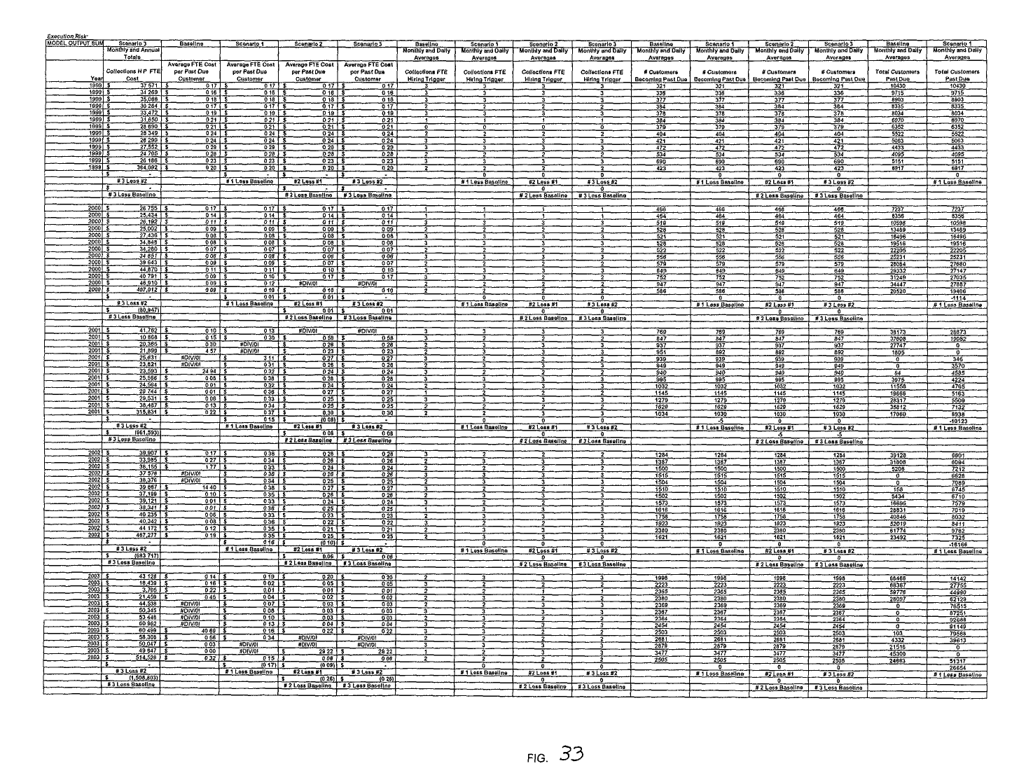

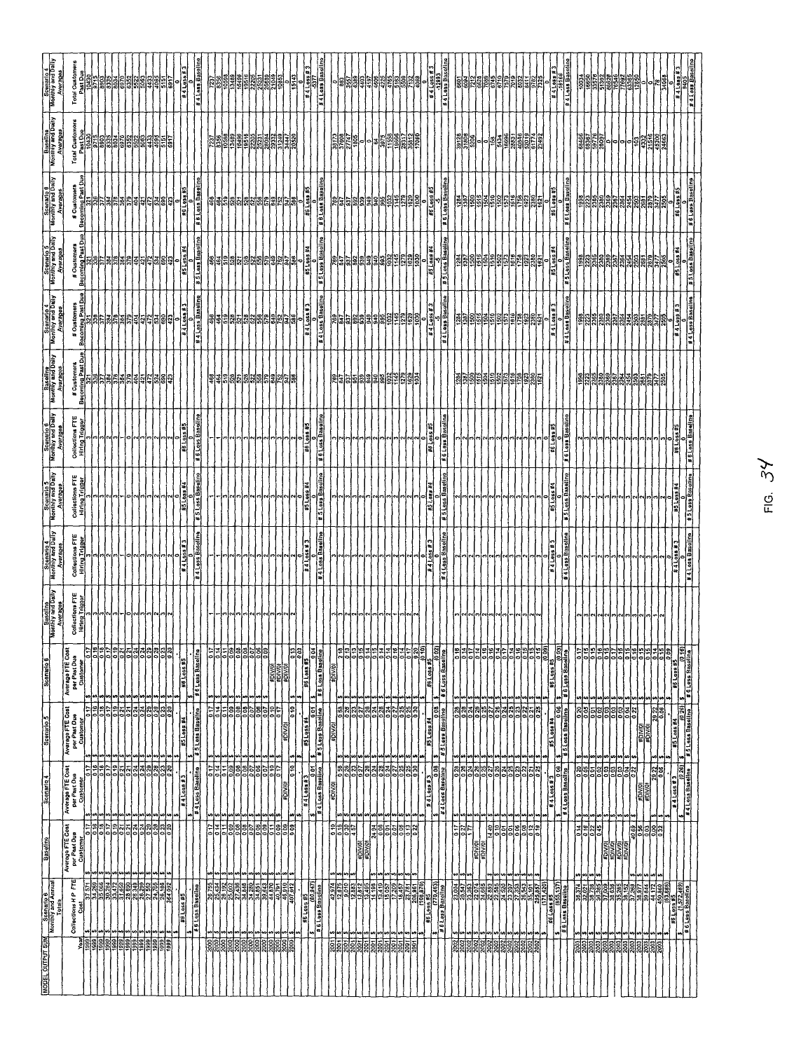

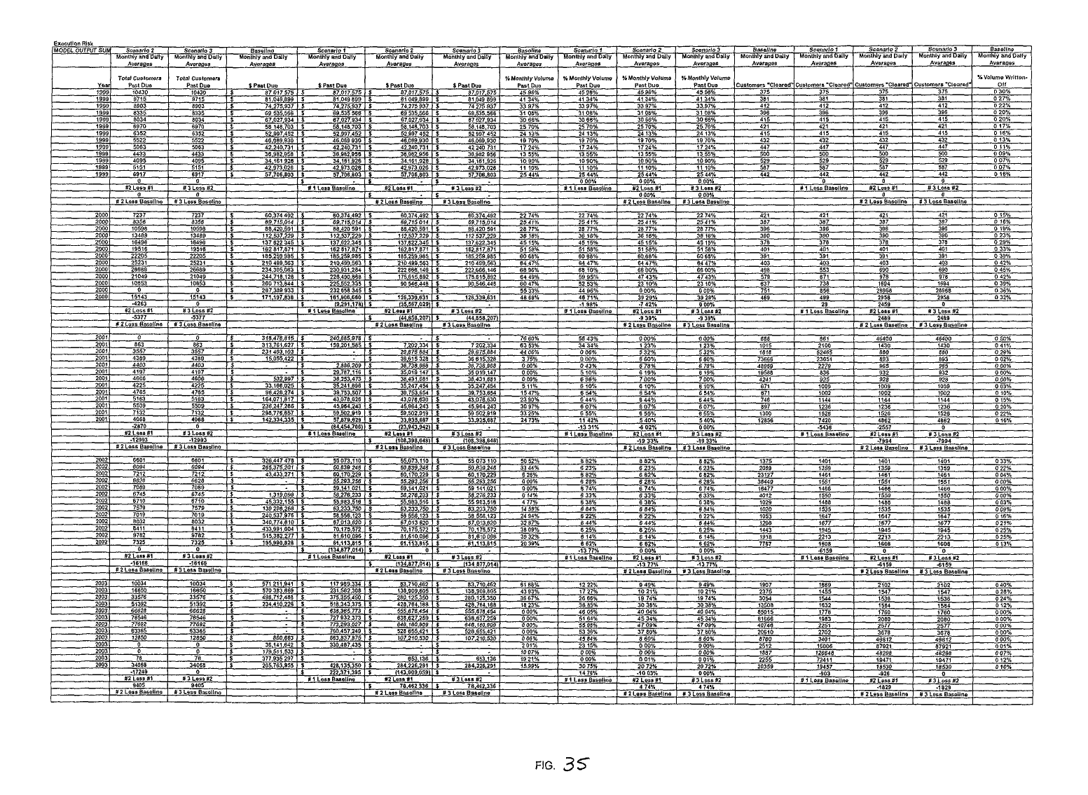

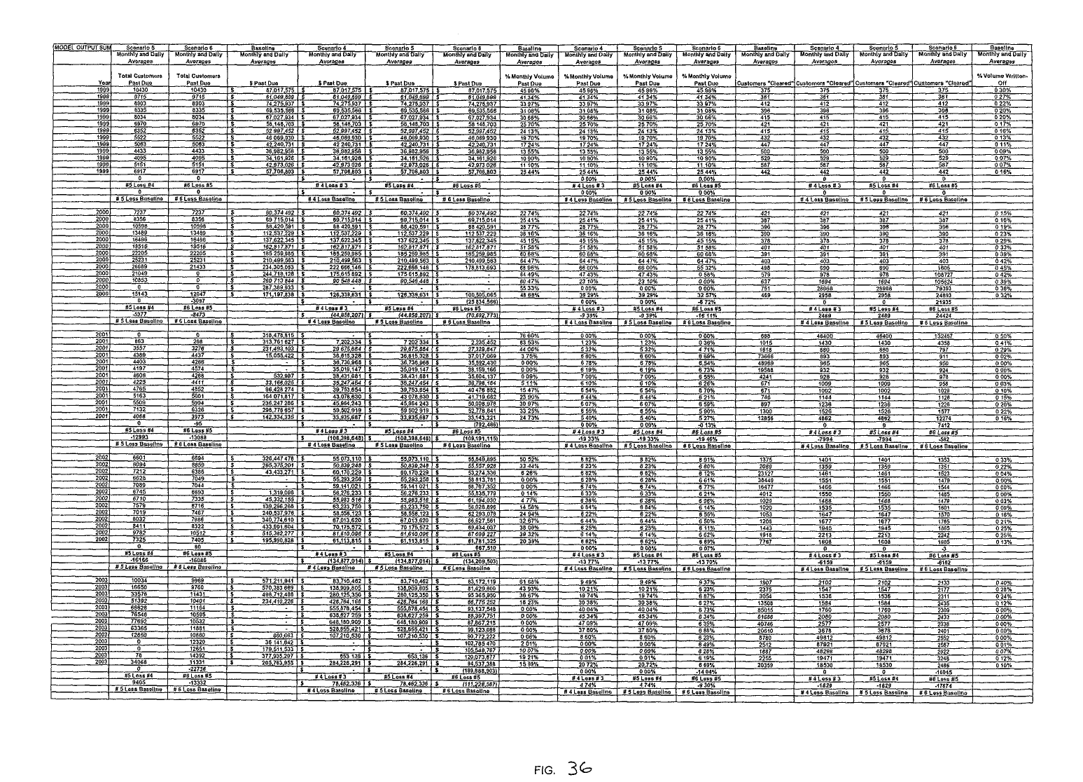

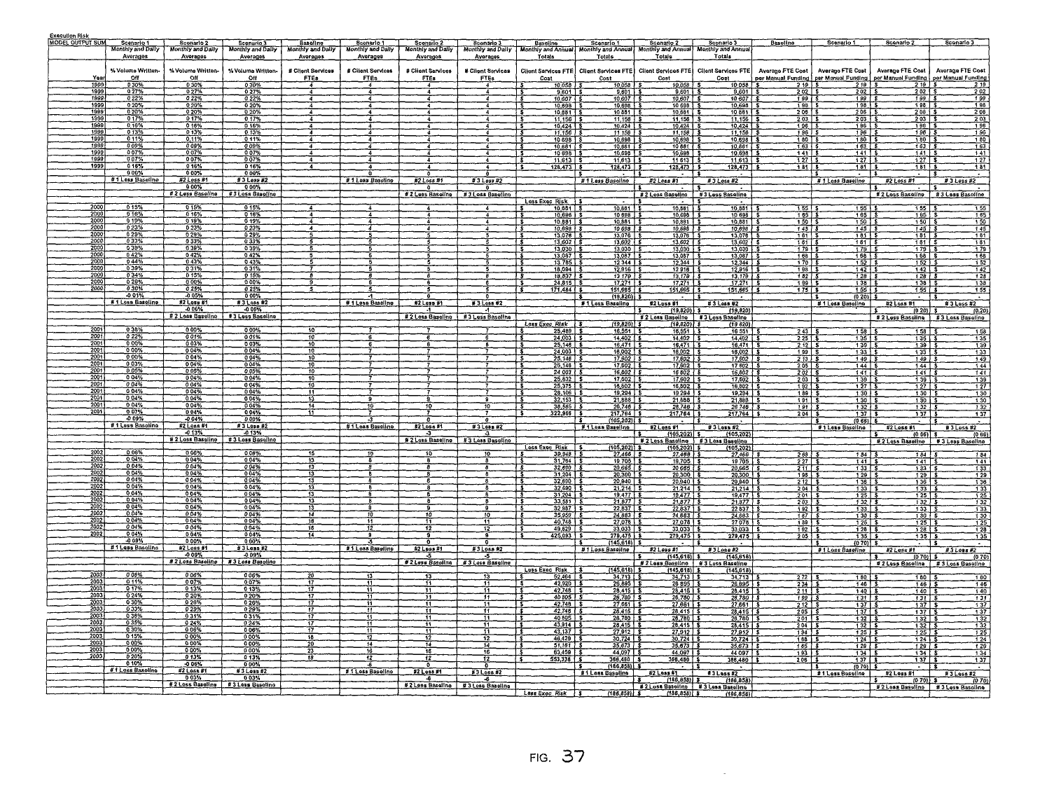

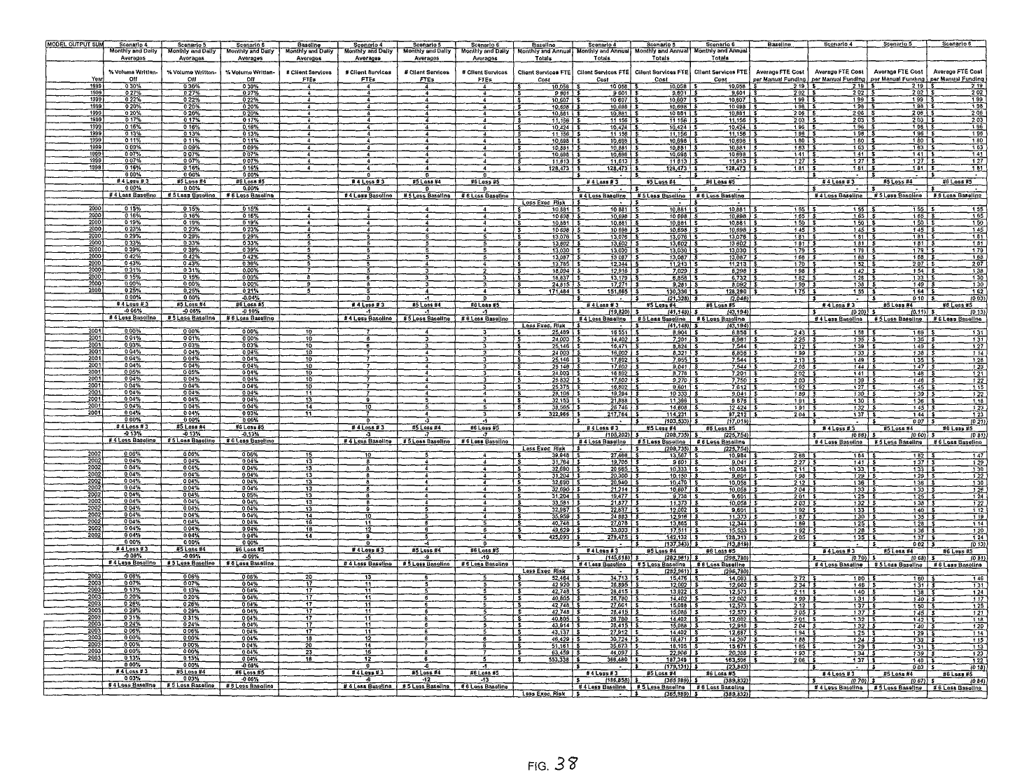

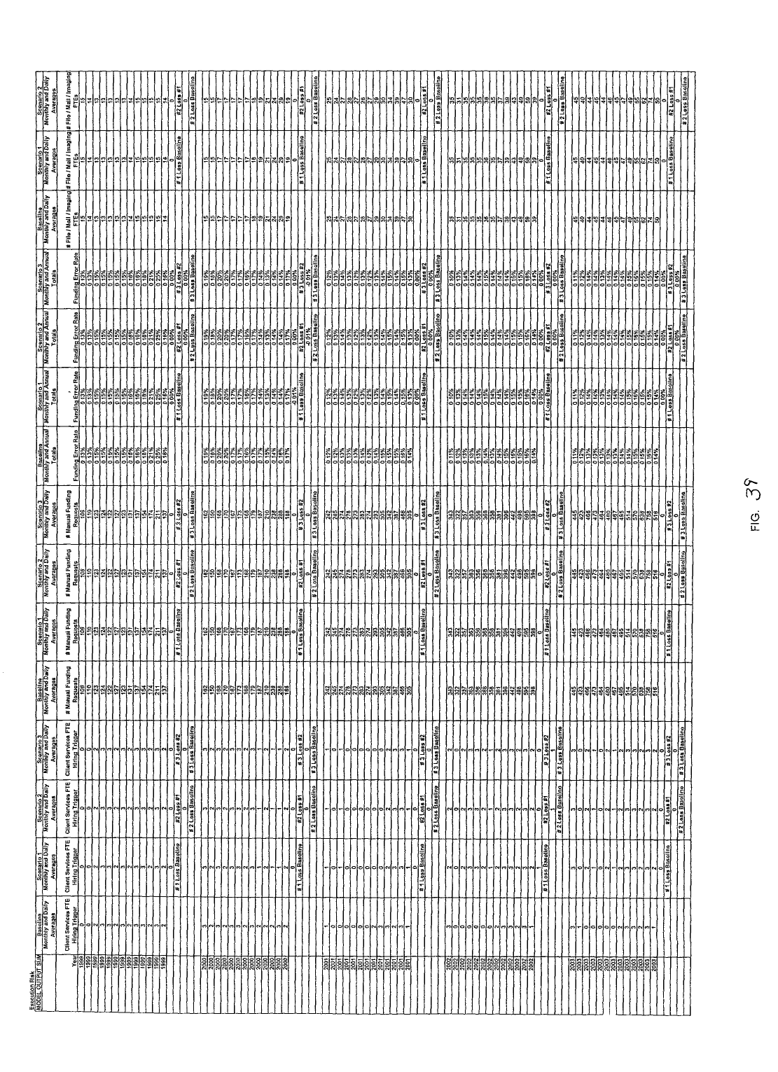

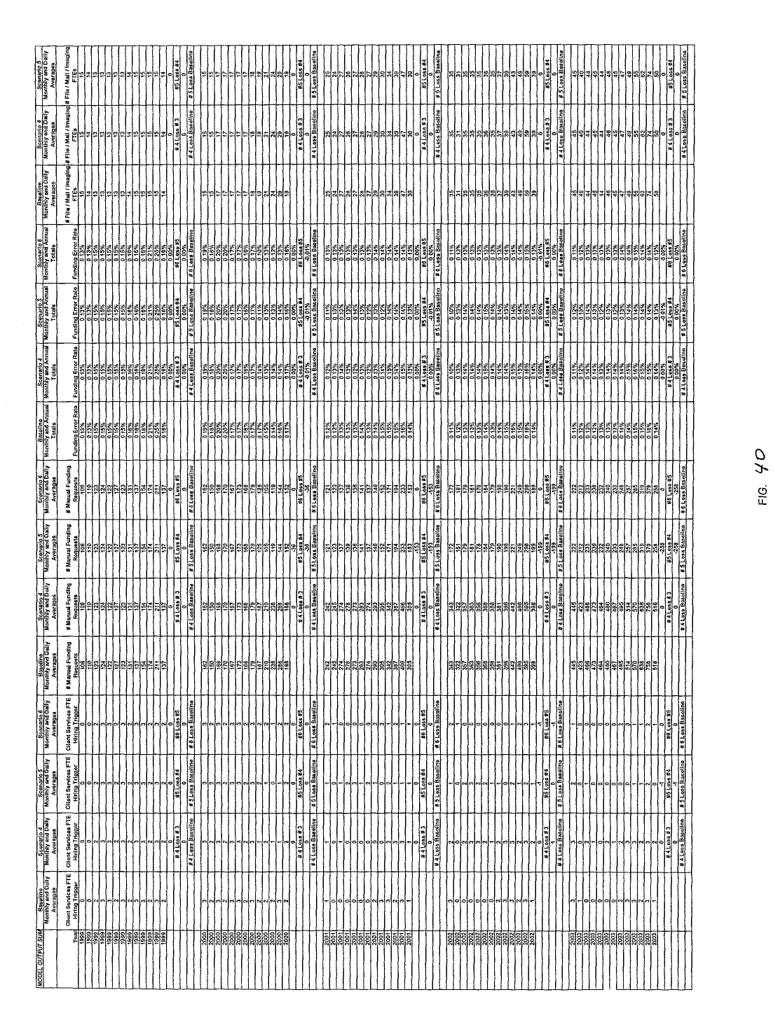

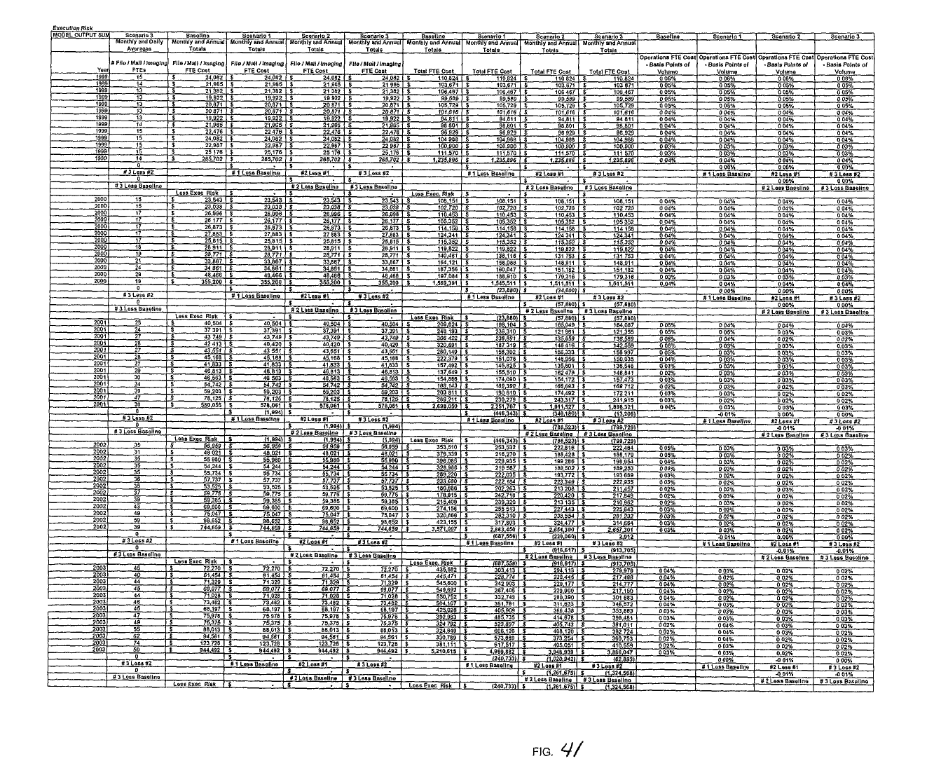

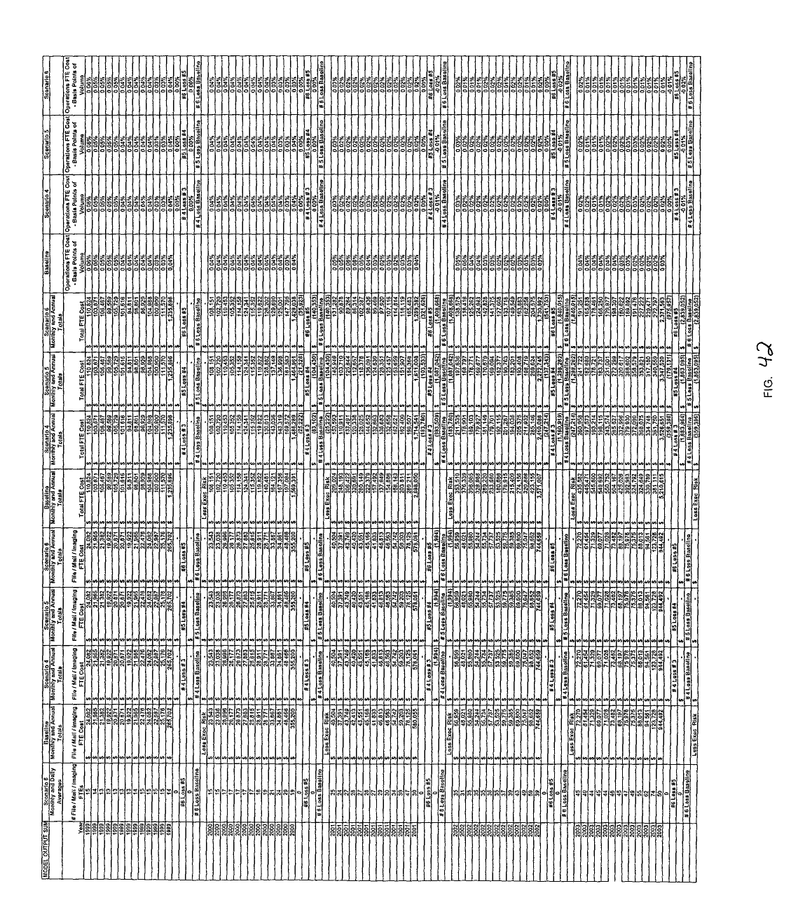

FIGS. 15 through 42 are a scenario summary report 250, which shows results of six scenarios run against a baseline scenario (shown in FIGS. 6 through 11). Report 250 indicates capacity and requirements over a period of years based upon the six scenarios. Although six scenarios are summarized in report 250, system 10 should not be construed as being so limited.

For the baseline scenario and the six scenarios run there is included monthly and annual totals for traditional business volume, E-commerce business volume, total business volume, assignments FTE cost, cash applications FTE cost, adjustments FTE cost, total collections FTE cost, client services FTE cost, a funding error rate, a file/mail/imaging FTE cost, and a total FTE cost.

Further included are monthly and daily averages for a number of assignments FTEs, an assignments FTE hiring trigger, a number of new manual invoices, a number of backlogged invoices, a daily manual invoice processing capacity, a number of cash applications FTEs, a cash applications FTE hiring trigger, a number of new manual payments, a number of backlogged payments, a number of manual payments application capacity, a number of adjustments FTEs, an adjustments FTE hiring trigger, a number of credit memos created, a number of other adjustments items created, an amount for adjustments items created, an amount of credit memos backlog, an amount of other adjustments backlog, a total adjustments backlog, a percent volume adjustments backlog, a number of credit memos completed, a number of other adjustments completed, a total amount of adjustments completed, a number of collections FTEs, a number of collections assistants, a collections FTE hiring trigger, a number of customer becoming past due, a total number of customers past due, a past due amount, a percent of monthly volume past due, a number of customers “cleared”, a percent of volume written-off, a number of client services FTEs, a client services FTE hiring trigger, a number of manual funding requests, and a number of file/mail/imaging FTEs.

Also generated for each scenario are an average FTE cost per invoice manually assigned, an average FTE cost per manual payment, an average FTE cost per manual adjustment, an average FTE cost per past due customer, an average FTE cost per manual funding, and a percentage operations FTE cost per basis point of volume.

The above described systems and methods for simulating business operations allows a user to objectively forecast a business's needs using data and rigor, providing a planning tool that is not based upon past trends and educated guesses. Such a system further allows for accurate and systematic planning for future growth, and thus avoiding consequences of incorrect planning such as bottlenecks, client dissatisfaction and potential client terminations. The system is able to identify problems through data collection and metrics analysis and then identify possible solutions through a determination of capacity, prioritization and benefits. Use of the system and methods described herein further allows user to determine capacity, for example, by increasing daily volume, until the number of employees needed to handle the volume increases beyond employee resources available, allowing a determination of future staffing needs.

While the invention has been described in terms of various specific embodiments, those skilled in the art will recognize that the invention can be practiced with modification within the spirit and scope of the claims.

What is claimed is:

1. A method for operating a computer to model operations of a business, said method comprising the steps of:
prompting a user to input data relating to at least one of volume, assignments, cash application, adjustments, collections, client services, tolerance, labor, file/mail/imaging, and capacity;
determining from the data whether the staff of the business has capacity to carry out tasks of the business; and
displaying at least one scenario generated from the input data and capacity determination.

2. A method according to claim 1 wherein said step of determining further comprises the step of determining an invoice processing capacity according to:
$$\frac{A \times B \times C \times 60 sec \text{/} min \times 60 min \text{/} hr \times ( 1 + D )}{E} ,$$
where A=a number of assignments for FTEs, B=net time worked, C=productive hours per day, D=a percentage of possible overtime, and E=an average invoice time in seconds.

3. A method according to claim 1 wherein said step of determining further comprises the step of determining a cash application capacity according to:
$$\frac{A \times B \times C \times 60 sec \text{/} min \times 60 min \text{/} hr \times ( 1 + D )}{E} ,$$
where A=a number of cash applications for FTEs, B=net time worked, C=productive hours per day, D=a percentage of possible overtime, and E=an average invoice time in seconds.

4. A method according to claim 1 wherein said step of determining further comprises the step of determining a number of cash application and invoice processing FTEs according to:
$$\frac{A \times B}{C \times D \times 60 sec \text{/} min \times 60 min \text{/} hr} ,$$
where A=an average invoice or application time in seconds, B=a number of new invoices or payments, C=net time worked and D=productive hours per day.

5. A method according to claim 1 wherein said step of determining further comprises the step of determining a collection capacity according to
a number of customers cleared today by calling+a number of customers cleared by write-off+a number of customers cleared without collections.

6. A method according to claim 5 wherein the number of customers cleared today by calling is defined as outbound calling effectiveness×a number of calls made today, outbound calling effectiveness is defined as a number calls made per day−a number of calls required to clear all customers,
the number of customers cleared by write-off is defined as a percentage of daily volume as bad debt×daily volume dollars÷an average customer past due amount,
the number of customers cleared without collections activity is defined as a percentage of daily volume as bad debt×daily volume in dollars÷an average customer past due amount,
the number of calls made per day is defined as a number FTE×productive hours per day×a percentage of collections work time for outbound calls÷average collections call time, and
the number of calls required to clear all customers is defined as number calls per customer per month to clear customer×total number past due customer÷number of dates of the month.

7. A method according to claim 1 wherein said step of determining further comprises the step of determining a number of collections FTEs according to
a number of collections FTEs+maximum number of collectors added at one hiring, where number of collections FTEs is defined as (a number of calls per month requesting to clear customers×a total number of customers past due×an average of collections call times×a time for outbound calls×net time worked)/(a number of dates of the month×a number of productive work hours).

8. A method according to claim 1 wherein said step of determining further comprises the step of determining a number of adjustments FTEs according to
(1+(a value of adjustments items created/an average adjustments item value)×an average adjustments action time in minutes)/productive hours per day×60).

9. A method according to claim 1 wherein said step of determining further comprises the step of determining an adjustments FTE cost according to
(a number of adjustments FTEs×an adjustments average hourly wage×7.5) if the adjustments FTE hiring trigger is less than 5, and
(a number of adjustments FTEs×an adjustments average hourly wage×7.5)+( a number of adjustments FTEs×an adjustments average hourly wage×7.5×1.5×0.4) if the adjustments FTE hiring trigger is greater than or equal to 5.

10. A method according to claim 1 wherein said step of determining further comprises the step of determining an adjustments capacity−a number of credit memos, wherein for an adjustments FTE hiring trigger of less than 2, the number credit memos completed is (a number of adjustments FTEs×a percentage of adjustments work clearing E-commerce items×productive hours per day×a percentage net time worked×60×(value of credit memos backlog/(value of credit memos backlog+value of other adjustments backlog)))/an average credit memo action time in minutes,
while for an adjustments FTE hiring trigger greater than or equal to 2, the number of credit memos completed is calculated as ((1+0.4)×a percentage of adjustments work clearing E-commerce items×(number of adjustments FTEs×productive hours per day×a percentage net time worked)×60×(value of credit memos backlog/(value of credit memos backlog+value of other adjustments backlog)))/an average credit memo action time in minutes, and adjustments capacity−number of other adjustments completed,
if the adjustments FTE hiring trigger is less than 2, the number of other adjustments completed is calculated as (a number of adjustments FTEs×a percentage of adjustments work clearing E-commerce items×productive hours per day×a percentage net time worked×60×(value of other adjustments backlog/(value of other adjustments backlog+value of credit memos backlog)))/an average adjustments action time in minutes (without credit memos),
while for an adjustments FTE hiring trigger greater than or equal to 2, a number of other adjustments completed is calculated as ((1+0.4)×a percentage of adjustments work clearing E-commerce items×(number of adjustments FTEs×productive hours per day×a percentage net time worked)×60×(value of other adjustments backlog/(value of credit memos backlog+value of other adjustments backlog)))/an average adjustments action time in minutes without credit memos.

11. A method according to claim 1 wherein said step of determining further comprises the step of determining a number of client service FTEs according to
the number of client services FTEs+1+0.0000477×a funding error rate, while if the funding error rate is less than or equal to the baseline funding error rate,
the number of client services FTEs is the number of current client services FTEs−1.

12. A method according to claim 1 wherein said step of determining further comprises the step of determining a client services FTE cost according to
a number of client services FTEs×an average hourly wage for client services FTEs×7.5 if the client services FTE hiring trigger is less than 5, and if the client services FTE hiring trigger greater than or equal to 5, client services FTE cost=(a number of client services FTEs×a client services average hourly wage×7.5)×(1+0.4×1.5).

13. A computer programmed to:
prompt a user to input data relating to at least one of volume, assignments, cash application, adjustments, collections, client services, tolerance, labor, file/mail/imaging, and capacity;
determine from the data whether the staff of the business has capacity to carry out tasks of the business; and
display a computer generated screen which comprises at least one scenario generated from the input data and capacity determination.

14. A computer according to claim 13 further programmed to determine an invoice processing capacity according to:
$$\frac{A \times B \times C \times 60 sec \text{/} min \times 60 min \text{/} hr \times ( 1 + D )}{E} ,$$
where A=a number of assignments for FTEs, B=net time worked, C=productive hours per day, D=a percentage of possible overtime, and E=an average invoice time in seconds.

15. A computer according to claim 13 further programmed to determine a cash application capacity according to:
$$\frac{A \times B \times C \times 60 sec \text{/} min \times 60 min \text{/} hr \times ( 1 + D )}{E} ,$$
where A a number of cash applications for FTEs, B=net time worked, C=productive hours per day, D=a percentage of possible overtime, and E=an average invoice time in seconds.

16. A computer according to claim 13 further programmed to determine a number of cash application and invoice processing FTEs according to:
$$\frac{A \times B}{C \times D \times 60 sec \text{/} min \times 60 min \text{/} hr} ,$$
where A=an average invoice or application time in seconds, B=a number of new invoices or payments, C=net time worked and D=productive hours per day.

17. A computer according to claim 13 further programmed to determine a collection capacity according to a number of customers cleared today by calling+a number of customers cleared by write-off+a number of customers cleared without collections.

18. A computer according to claim 5 further programmed to:
determine the number of customers cleared today by calling as outbound calling effectiveness×a number of calls made today, outbound calling effectiveness is defined as a number calls made per day÷a number of calls required to clear all customers,
determine the number of customers cleared by write-off as a percentage of daily volume as bad debt×daily volume dollars÷an average customer past due amount,
determine the number of customers cleared without collections activity as a percentage of daily volume as bad debt×daily volume in dollars÷an average customer past due amount,
determine the number of calls made per day as a number of FTEs×productive hours per day×a percentage of collections work time for outbound calls÷average collections call time; and
determine the number of calls required to clear all customers as a number calls per customer per month to clear customer×total number past due customer÷number of dates of the month.

19. A computer according to claim 13 further programmed to determine a number of collections FTEs according to a number of collections FTEs+maximum number of collectors added at one hiring, where the number of collections FTEs is defined as (a number of calls per month requesting to clear customers×a total number of customers past due×an average of collections call times×a time for outbound calls×net time worked)/(a number of dates of the month×a number of productive work hours).

20. A computer according to claim 13 further programmed to determine a number of adjustments FTEs according to (1+(a value of adjustments items created/an average adjustments item value)×an average adjustments action time in minutes)/(productive hours per day×60).

21. A computer according to claim 13 further programmed to:
determine an adjustments FTE cost according to (a number of adjustments FTEs×an adjustments average hourly wage×7.5) if the adjustments FTE hiring trigger is less than 5; and
determine an adjustments FTE cost according to (a number of adjustments FTEs×an adjustments average hourly wage×7.5)+(a number of adjustments FTEs×an adjustments average hourly wage×7.5×1.5×0.4) if the adjustments FTE hiring trigger is greater than or equal to 5.

22. A computer according to claim 13 further programmed to determine an adjustments capacity—a number of credit memos, wherein for an adjustments FTE hiring trigger of less than 2, the number credit memos completed is (a number of adjustments FTEs×a percentage of adjustments work clearing E-commerce items×productive hours per day×a percentage net time worked×60×(value of credit memos backlog/(value of credit memos backlog+value of other adjustments backlog)))/an average credit memo action time in minutes,
while for an adjustments FTE hiring trigger greater than or equal to 2, the number of credit memos completed is calculated as ((1+0.4)×a percentage of adjustments work clearing E-commerce items×(number of adjustments FTEs×productive hours per day×a percentage net time worked)×60×(value of credit memos backlog/(value of credit memos backlog+value of other adjustments backlog)))/an average credit memo action time in minutes, and adjustments capacity—number of other adjustments completed,
if the adjustments FTE hiring trigger is less than 2, the number of other adjustments completed is calculated as (a number of adjustments FTEs×a percentage of adjustments work clearing E-commerce items×productive hours per day×a percentage net time worked×60×(value of other adjustments backlog/(value of other adjustments backlog+value of credit memos backlog)))/an average adjustments action time in minutes (without credit memos), while for an adjustments FTE hiring trigger greater than or equal to 2, a number of other adjustments completed is calculated as ((1+0.4)×a percentage of adjustments work clearing E-commerce items×(number of adjustments FTEs×productive hours per day×a percentage net time worked)×60×(value of other adjustments backlog/(value of credit memos backlog+value of other adjustments backlog)))/an average adjustments action time in minutes without credit memos.

23. A computer according to claim 13 further programmed to:
determine a number of client service FTEs according to the number of client services FTEs+1+0.0000477×a funding error rate, and if the funding error rate is less than or equal to the baseline funding error rate, determine a number of client service FTEs according to a number of client services FTEs required=the number of client services FTEs−1.

24. A computer according to claim 13 further programmed to:
determine a client services FTE cost according to a number of client services FTEs×an average hourly wage for client services FTEs×7.5 if the client services FTE hiring trigger is less than 5, and
if the client services FTE hiring trigger greater than or equal to 5, determine a client services FTE cost according to client services FTE cost=(a number of client services FTEs×a client services average hourly wage×7.5)×(1+0.4×1.5).

25. A database comprising:
data corresponding to at least one of a business' volume, assignments, cash applications, adjustments, collections, client services, tolerance, labor, and file/mail/imaging; and
data corresponding to a determination of a number of employees needed to carry out tasks of the business.

26. A database according to claim 25 wherein said data corresponding to a business further comprises:
data corresponding to at least one of a monthly volume for each month of the calendar year;
data corresponding to an annual increase in volume for at least one year; and
data corresponding to daily volume ratios/monthly volume conversion constant for at least one of a 1st Monday, a 1st Tuesday, a 1st Wednesday, a 1st Thursday, a 1st Friday, a 2nd Monday, a 2nd Tuesday, a 2nd Wednesday, a 2nd Thursday, a 2nd Friday, a 3rd Monday, a 3rd Tuesday, a 3rd Wednesday, a 3rd Thursday, a 3rd Friday, a 4th Monday, a 4th Tuesday, a 4th Wednesday, a 4th Thursday, a 4th Friday, a 5th Monday, and a 5th Tuesday.

27. A database according to claim 25 wherein said data corresponding to a business further comprises data corresponding to at least one of an average number of invoices per payment, a percent adjustments work actually clearing an item, a percent adjustments created by customer accounts receivable item error, a percent adjustments from other error, a percent adjustments created by client accounts receivable item error, a percent accounts receivable items with no error, a percent adjustments created by client/customer mix accounts receivable item error, a number of credit memos per dollar monthly volume, an average credit memo value, an average credit memo action time (minutes), an average adjustments hourly wage, an average adjustments action time, and an average adjustment item value.

28. A database according to claim 25 wherein said data corresponding to a business further comprises data corresponding to at least one of an average cash applications hourly wage, an average payment application time, a percentage of cash applications work/time not spent on original applications, a cash applications error acceleration factor, and an average number of manual payments per dollar volume.

29. A database according to claim 25 wherein said data corresponding to a business further comprises data corresponding to at least one of an average number of invoices per payment, a percentage of adjustments work actually clearing an item, a percentage of adjustments created by customer accounts receivable item error, a percentage of adjustments from other errors, a percentage of adjustments created by client accounts receivable item error, a percentage of accounts receivable items with no error, a percentage of adjustments created by client/customer mixing accounts receivable items error, a number of credit memos per dollar monthly volume, an average credit memo value, an average credit memo action time, an average adjustments hourly wage, an average adjustment action time, and an average adjustment item value.

30. A database according to claim 25 wherein said data corresponding to a business further comprises data corresponding to at least one of an average collections hourly wage, an average hourly wage for collections assistants, a ratio of assistants to collectors, a maximum number of collectors, an average collections call time, a percentage of collections work/time not spent on outbound calls, a percentage of volume becoming overdue, an average past due sum per past due customer, a percentage past due becoming bad debt, a percentage overdue paying without collections activity, a number of calls per month required to clear customers, and a maximum number of collectors added in one hiring.

31. A database according to claim 25 wherein said data corresponding to a business further comprises data corresponding to at least one of an average client services hourly wage, a baseline funding error rate (percent total fundings), a percentage of client services work time not funding, a client services accuracy coefficient, and a number of manual funding requests per dollar monthly volume.

32. A database according to claim 25 wherein said data corresponding to a business further comprises data corresponding to at least one of allowable assignments backlog (invoices/day), allowable cash application backlog (records/day), allowable adjustments backlog (percent monthly volume), and allowable collections percent volume past due.

33. A database according to claim 25 wherein said data corresponding to a business further comprises data corresponding to at least one of a number of productive work-hours per day, a percentage of total available hours not worked, a number of work-days allowable missed tolerance, and a percentage of overtime possible.

34. A database according to claim 25 wherein said data corresponding to a business further comprises data corresponding to at least one of an average file/mail/imaging department hourly wage and a number of file/mail/imaging FTEs required per dollar monthly volume.

35. A database according to claim 25 wherein said data corresponding to a business further comprises data corresponding to at least one of a maximum allowable assignments FTEs, a maximum allowable cash application FTEs, a maximum allowable adjustments FTEs, a maximum allowable collections FTEs, a maximum allowable client services FTEs, and a maximum allowable file/mail/imaging FTEs.

36. A system financial services business system for managing operations, said system comprising:
a computer;
a storage device for storing information;
a server configured to determine an operations capacity for the business based upon data relating to at least one of volume, assignments, cash application, adjustments, collections, client services, tolerance, labor, and file/mail/imaging; said server, said server further configured to be coupled to said computer via a network; and
a database comprising data corresponding to at least one of a business' volume, assignments, cash applications, adjustments, collections, client services, tolerance, labor, and file/mail/imaging and data corresponding to a determination of a number of employees needed to carry out tasks of the business.

37. A system according to claim 36 wherein said network is at least one of the Internet, an intranet, a local area network (LAN), a wide area network (WAN), dial-in-connections, cable modems, and high-speed ISDN lines.

38. A system according to claim 36 wherein said server is further configured to calculate a daily capacity of the number of employees as
$$\frac{A \times B \times C \times 60 sec \text{/} min \times 60 min \text{/} hr \times ( 1 + D )}{E} ,$$
where A=number FTEs, B=net time worked (hours), C=productive hours per day, D=a percentage of possible overtime, and E=average time (seconds).

39. A system according to claim 36 wherein said server is further configured to calculate a number of backlogged invoices as a number of new manual invoices+a number backlogged invoices−a number invoices processed, wherein the number of new manual invoices is defined as (daily volume×average manual invoices per 1 MM monthly volume)+(E-commerce business daily volume×e-commerce average manual invoices per 1 MM monthly volume).

40. A system according to claim 36 wherein said server is further configured to calculate a number of backlogged records as a number new manual records+a number of backlogged records−a number records applied, wherein a number of new manual records is defined as core daily net volume×core average payments per 1 MM monthly volume+E-business daily net volume×E-business average manual payment per 1 MM monthly volume.

41. A system according to claim 36 wherein said server is further configured to calculate a collections capacity, the total number of customers cleared today, as a number of customers cleared today by calling+a number of customers cleared by write-off+a number of customers cleared without collections activity, where the number customers cleared today by calling is defined as outbound calling effectiveness×number calls made today, outbound calling effectiveness is defined as a number of calls made per day/a number of calls required to clear all customers, a number customers cleared by write-off is defined as a percentage of daily volume as bad debt×a daily volume amount÷an average customer past due amount, a number calls made per day is defined as a number of customers becoming past due×a percentage of past due customers paying without collections activity, a number of customers cleared without collections activity (calling or write-off) is defined as number of customers becoming past due×a percentage of past due customers paying without collections activity and a number calls required to clear all customers is defined as (a number of calls per customer per month to clear customer×a total number of past due customers)/a number of dates of the month.

42. A system according to claim 36 wherein said server is further configured to calculate a number of collections FTEs according to a number of collections FTEs+a maximum number collectors added at one hiring, and where a number of collections FTEs is defined as ((a number of calls per month requesting to clear customers×a total number of customers past due×an average of collections call times×a time for outbound calls×net time worked)/(a number of dates of the month×a number of productive work hours))−a number of collections FTEs.

43. A system according to claim 36 wherein said server is further configured to calculate a number of adjustments FTEs as (1+(a value of adjustments items created/an average adjustments item value)×an average adjustments action time in minutes)/(productive hours per day×60), if an adjustments backlog volume is greater than monthly adjustments backlog volume tolerance, and as number adjustments FTEs−1 if an adjustments backlog volume is less than or equal to monthly adjustments backlog volume tolerance.

44. A system according to claim 36 wherein said server is further configured to calculate a number of client services FTEs as the number of client services FTEs+1+0.0000477×a funding error rate, if the funding error rate is less than or equal to a baseline funding error rate, the number of client services FTEs is calculated as the number of client services FTEs−1.

45. A computer program embodied on a computer-readable medium for managing business operations, comprising:
a code segment to process data relating to at least one of a business' volume, assignments, cash application, adjustments, collections, client services, tolerance, labor, and file/mail/imaging; and
a code segment to analyze based on a plurality of rules for calculating a number of employees needed to carry out tasks of the business.

46. A computer program according to claim 45 wherein the plurality of rules are at least one of a rule for calculating a daily capacity of the number of employees, a rule for calculating a number of collections FTEs, a rule for calculating a number of adjustments FTEs and a rule for calculating a number of client services FTEs.

47. A computer program according to claim 46 wherein the rule for calculating a daily capacity of the number of employees is
$$\frac{A \times B \times C \times 60 sec \text{/} min \times 60 min \text{/} hr \times ( 1 + D )}{E} ,$$
where A=number FTEs, B=net time worked (hours), C=productive hours per day, D=a percentage of possible overtime, and E=average time (seconds).

48. A computer-readable medium according to claim 46 wherein the rule for calculating a revised number of collections FTEs is a current number of collections FTEs+a maximum number of collectors added at one hiring, where the current number of collections FTEs is defined as ((a number of calls per month requesting to clear customers×a total number of customers past due×an average of collections call times×a time for outbound calls×net time worked)/(a number of dates of the month×a number of productive work hours))−a number of collections FTEs.

49. A computer-readable medium according to claim 46 wherein the rule for calculating a number of adjustments FTEs is (1+(a value of adjustments items created/an average adjustments item value)×an average adjustments action time in minutes)/( productive hours per day×60), if an adjustments backlog volume is greater than monthly adjustments backlog volume tolerance, and as number adjustments FTEs−1 if an adjustments backlog volume is less than or equal to monthly adjustments backlog volume tolerance.

50. A computer-readable medium according to claim 46 wherein the rule for calculating a number of client services FTEs is the number of client services FTEs+1+0.0000477×a funding error rate, if the funding error rate is less than or equal to a baseline funding error rate, the number of client services FTEs is calculated as the number of client services FTEs−1.
